(19) United States
(12) Patent Application Publication
(10) Pub. No.: US 2024/0333455 A1
(43) Pub. Date: Oct. 3, 2024

(54) METHOD AND APPARATUS FOR CONFIGURING TIME DOMAIN POSITION OF REFERENCE SIGNAL, USER EQUIPMENT, BASE STATION, AND STORAGE MEDIUM

(71) Applicant: Beijing Xiaomi Mobile Software Co., Ltd., Beijing (CN)

(72) Inventor: Xuemei QIAO, Beijing (CN)

(21) Appl. No.: 18/576,981

(22) PCT Filed: Jul. 8, 2021
(86) PCT No.: PCT/CN2021/105343

§ 371 Date: Jan. 5, 2024

(51) Int. Cl. H04L 5/00; H04W 72/0446

(52) U.S. Cl. CPC H04L 5/0051; H04W 72/0446

(57) ABSTRACT

A method for configuring a time domain position of a reference signal is performed by a user equipment (UE), and includes: determining an available symbol in a special slot, and acquiring a parameter configured and/or indicated by a base station; determining a symbol resource for data communication in the special slot and at least one first demodulation reference signal (DMRS) symbol offset value based on the parameter; and determining a first time domain position of a DMRS based on a first available symbol in the symbol resource and the at least one first DMRS symbol offset value.

### CROSS REFERENCE TO RELATED APPLICATION

This application is a US national phase application of International Application No. PCT/CN2021/105343, filed on Jul. 8, 2021, the entire content of which is incorporated herein by reference.

### TECHNICAL FIELD

The present disclosure relates to the field of communication technologies, in particularly, to a method and an apparatus for configuring a time domain position of a reference signal, a user equipment, a base station and a storage medium.

### BACKGROUND

In a communication system, when uplink slot resources are insufficient, in order to reduce a communication delay and improve a coding efficiency, an uplink symbol resource in a special slot allocated by a base station is generally used for uplink TBoMS (transmission block processing over multi-slot transmission) communication. When the uplink TBoMS communication by using the special slot is performed, it is generally required to determine a time domain position of a DRMS in the special slot to perform DRMS communication.

### SUMMARY

In an aspect, an embodiment of the present disclosure provides a method for configuring a time domain position of a reference signal, performed by a user equipment (UE). The method includes:
determining an available symbol in a special slot, and acquiring a parameter configured and/or indicated by a base station;
determining a symbol resource for data communication in the special slot and at least one first demodulation reference signal (DMRS) symbol offset value based on the parameter; and
determining a first time domain position of the DMRS based on a first available symbol in the symbol resource and the at least one first DMRS symbol offset value.

In another aspect, an embodiment of the present disclosure provides a method for configuring a time domain position of a reference signal, performed by a base station. The method includes:
determining an available symbol in a special slot and a parameter;
determining a symbol resource for data communication in the special slot and at least one first DMRS symbol offset value based on the parameter; and
determining a first time domain position of the DMRS based on a first available symbol in the symbol resource and the at least one first DMRS symbol offset value.

In still another aspect, an embodiment of the present disclosure provides a communication device. The device includes a processor and a memory having a computer program stored thereon. The processor is configured to:
determine an available symbol in a special slot, and acquire a parameter configured and/or indicated by a base station;
determine a symbol resource for data communication in the special slot and at least one first demodulation reference signal (DMRS) symbol offset value based on the parameter; and
determine a first time domain position of the DMRS based on a first available symbol in the symbol resource and the at least one first DMRS symbol offset value.

### BRIEF DESCRIPTION OF THE DRAWINGS

The above-mentioned and/or additional aspects and advantages of the present disclosure will be apparent and readily understood from the following description of embodiments taken in conjunction with the accompanying drawings, in which:

FIG. 1 is a flowchart illustrating a method for configuring a time domain position of a reference signal according to an embodiment of the present disclosure.

FIG. 2 is a flowchart illustrating a method for configuring a time domain position of a reference signal according to another embodiment of the present disclosure.

FIG. 3 is a flowchart illustrating a method for configuring a time domain position of a reference signal according to yet another embodiment of the present disclosure.

FIG. 4 is a flowchart illustrating a method for configuring a time domain position of a reference signal according to yet another embodiment of the present disclosure.

FIG. 5 is a flowchart illustrating a method for configuring a time domain position of a reference signal according to yet another embodiment of the present disclosure.

FIG. 6 is a flowchart illustrating a method for configuring a time domain position of a reference signal according to yet another embodiment of the present disclosure.

FIG. 7 is a flowchart illustrating a method for configuring a time domain position of a reference signal according to yet another embodiment of the present disclosure.

FIG. 8 is a flowchart illustrating a method for configuring a time domain position of a reference signal according to yet another embodiment of the present disclosure.

FIG. 9 is a flowchart illustrating a method for configuring a time domain position of a reference signal according to yet another embodiment of the present disclosure.

FIG. 10 is a flowchart illustrating a method for configuring a time domain position of a reference signal according to yet another embodiment of the present disclosure.

FIG. 11 is a flowchart illustrating a method for configuring a time domain position of a reference signal according to yet another embodiment of the present disclosure.

FIG. 12 is a flowchart illustrating a method for configuring a time domain position of a reference signal according to yet another embodiment of the present disclosure.

FIG. 13 is a flowchart illustrating a method for configuring a time domain position of a reference signal according to yet another embodiment of the present disclosure.

FIG. 14 is a flowchart illustrating a method for configuring a time domain position of a reference signal according to yet another embodiment of the present disclosure.

FIG. 15 is a flowchart illustrating a method for configuring a time domain position of a reference signal according to yet another embodiment of the present disclosure.

FIG. 16 is a schematic diagram illustrating a structure of an apparatus for configuring a time domain position of a reference signal according to an embodiment of the present disclosure.

FIG. 17 is a schematic diagram illustrating a structure of an apparatus for configuring a time domain position of a reference signal according to another embodiment of the present disclosure.

FIG. 18 is a block diagram illustrating a user equipment according to an embodiment of the present disclosure.

FIG. 19 is a block diagram illustrating a base station according to an embodiment of the present disclosure.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the disclosure. Instead, they are merely examples of apparatuses and methods consistent with aspects related to the disclosure as recited in the appended claims.

Terms used herein in embodiments of the present disclosure are only for the purpose of describing specific embodiments, but should not be construed to limit the present disclosure. As used in the embodiments of the present disclosure and the appended claims, “a/an” and “the” in singular forms are intended to include plural forms, unless clearly indicated in the context otherwise. It should also be understood that, the term “and/or” used herein represents and contains any or all possible combinations of one or more associated listed items.

It should be understood that, although terms such as “first,” “second” and “third” may be used in embodiments of the present disclosure for describing various information, this information should not be limited by these terms. These terms are only used for distinguishing information of the same type from each other. For example, first information may also be referred to as second information, and similarly, the second information may also be referred to as the first information, without departing from the scope of embodiments of the present disclosure. As used herein, the term “if” may be construed to mean “when” or “upon” or “in response to determining” depending on the context.

Embodiments of the present disclosure are described in detail below, examples of which are illustrated in the accompanying drawings. The same or similar reference numerals represent the same or similar elements throughout the descriptions. The embodiments described below with reference to the accompanying drawings are illustrative, are intended to explain the present disclosure and cannot be construed as limiting the present disclosure.

In a method for configuring a time domain position of a reference signal provided in embodiments of the present disclosure, a UE may determine a symbol for uplink communication in a special slot, acquire a parameter configured and/or indicated by a base station, and determine a symbol resource for data communication in the special slot and at least one first DMRS symbol offset value based on the parameter configured and/or indicated by the base station. Afterwards, the UE determines a first time domain position of a DMRS based on a first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

A method and an apparatus for configuring a time domain position of a reference signal, a user equipment, a base station and a storage medium provided by the present disclosure are described in detail with reference to the accompany drawings below.

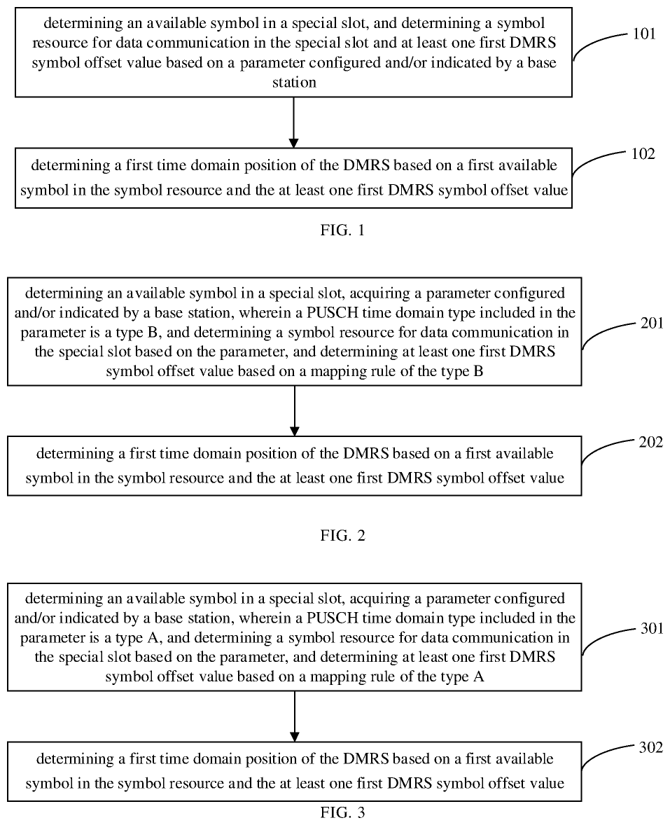

FIG. 1 is a flowchart illustrating a method for configuring a time domain position of a reference signal according to an embodiment of the present disclosure. The method is performed by a UE. As illustrated in FIG. 1, the method for configuring the time domain position of the reference signal may include the following steps.

At step 101, an available symbol in a special slot is determined, and a symbol resource for data communication in the special slot and at least one first DMRS symbol offset value are determined based on a parameter configured and/or indicated by a base station.

It should be noted that the method indicated in an embodiment of the present disclosure may be performed by any UE. The UE may refer to a device that provides voice and/or data connectivity to a user. The UE may communicate with one or more core networks through a radio access network (RAN). The UE may be an Internet of Things terminal, such as a sensor device, a mobile phone (or called as “cellular” phone), or a computer with the Internet of Things terminal, which may be, for example, a fixed, portable, pocket, handheld, computer built-in, or vehicle mounted device, such as, a station (STA), a subscriber unit, a subscriber station, a mobile station, a mobile platform, a remote station, an access point, a remote terminal, an access terminal, a user terminal, or a user agent. Alternatively, the UE may also be a device of unmanned aerial vehicle. Alternatively, the UE may also be a vehicle mounted device, such as a vehicle computer with wireless communication function or an external wireless terminal connected to the vehicle computer. Alternatively, the UE may also be a roadside device, such as a street light, a signal light, or other roadside device with wireless communication function.

In an embodiment of the present disclosure, the method for configuring the time domain position of the reference signal of embodiments of the present disclosure is applied in a scenario where intra-slot frequency hopping is disabled.

In an embodiment of the present disclosure, determining the available symbol in the special slot may include: determining an unavailable symbol from the special slot based on a slot format indicator (SFI) dynamic indication signaling and/or a semi-persistent slot format configuration signaling and/or other dynamic indication signalings and/or other high-layer configuration signalings sent by the base station; determining the available symbol to be a symbol in the special slot other than the unavailable symbol.

In an embodiment of the present disclosure, the unavailable symbol includes at least one of:
a guard interval symbol used by downlink to uplink conversion;
a downlink symbol for downlink communication;
a symbol for synchronization signal block (SSB) communication;
a symbol allocated to a common search space (CSS) (e.g. CSS #0);
a symbol occupied by a communication cancel indication (CI); or
a symbol used for business communication with a higher priority than current data communication.

In an embodiment of the present disclosure, when a symbol in the special slot satisfies any of the above conditions, it is that the symbol is the unavailable symbol.

Further, in an embodiment of the present disclosure, the above parameter may include at least one of:
a physical uplink shared channel (PUSCH) mapping type, in which, in an embodiment of the present disclosure, the PUSCH mapping type includes a type A and a type B;
a symbol length for data communication in the special slot;
a start symbol position for data communication in the special slot;
a DMRS-additional position;
a number of DMRS ports;
whether to enable intra-slot frequency hopping; or
a DMRS-type A position (a front-loaded DMRS-type A position).

It should be noted that, in an embodiment of the present disclosure, the DMRS-type A Position parameter is a parameter for PUSCH mapping type A. Based on this, when the PUSCH mapping type is type B, the DMRS-type A Position parameter is invalid, and when the PUSCH mapping type is type A, the DMRS-type A Position parameter is valid.

In an embodiment of the present disclosure, the UE may determine whether a symbol type of the DMRS is a single symbol DMRS or a double symbol DMRS by querying the following Table 1 based on a configuration type of the DMRS and the number of DMRS ports in the above parameter. In an embodiment of the present disclosure, the configuration type of the DMRS may be configured to the UE by the base station through a RRC (radio resource control) high-layer parameter. Furthermore, in an embodiment of the present disclosure, the configuration type of the DMRS includes a type 1 and a type 2.

TABLE 1

| | | Sopported antenna ports \tilde{p} | |
|---|---|---|---|
| DMRS duration | l′ | Configuration type 1 | Configuration type 2 |
| single-symbol DMRS | 0 | 0-3 | 0-5 |
| double-symnol DMRS | 0, 1 | 0-7 | 0-11 |

As illustrated in Table 1, when the configuration type of the DMRS is the type 1, the symbol type of the DMRS is determined as the single symbol DMRS in case of the number of DMRS ports being less than or equal to 4, while the symbol type of the DMRS is determined as the double symbol DMRS in case of the number of DMRS ports being greater than 4. When the configuration type of the DMRS is the type 2, the symbol type of the DMRS is determined as the single symbol DMRS in case of the number of DMRS ports being less than or equal to 8, while the symbol type of the DMRS is determined as the double symbol DMRS in case of the number of DMRS ports being greater than 8.

The following will describe the specific method that the UE acquires the parameter configured and/or indicated by the base station in detail.

More specifically, in an embodiment of the present disclosure, a method for acquiring the “DMRS-additional position” in the parameter may include acquiring the “DMRS-additional position” through a radio resource control (RRC) high-layer signaling sent by the base station.

In another embodiment of the present disclosure, a method for acquiring the “DMRS-type A position” in the parameter may include acquiring the “DMRS-type A position” through a system broadcast message master information block (MIB) sent by the base station.

In another embodiment of the present disclosure, a method for acquiring the “PUSCH mapping type, or symbol length for data communication in the special slot, or start symbol position for data communication in the special slot” in the parameter may include acquiring the “PUSCH mapping type, or symbol length for data communication in the special slot, or start symbol position for data communication in the special slot” through a high-layer signaling sent by the base station and a dynamic indication of the base station.

Specifically, in an embodiment of the present disclosure, the method of acquiring the PUSCH mapping type, or the symbol length for data communication in the special slot, or the start symbol position for data communication in the special slot through the high-layer signaling sent by the base station and the dynamic indication of the base station may include: acquiring, by the UE, a time domain resource allocation table sent by the base station through the high-layer signaling, in which, an uplink time domain resource allocation table includes at least one set of time domain resources, each set of time domain resources corresponds to an index, and each set of time domain resources at least includes at least one of the following parameters: the PUSCH mapping type, the symbol length for data communication in the special slot, and the start symbol position for data communication in the special slot; afterwards, acquiring an index of the dynamic indication of the base station to determine a time domain resource matching the index from the time domain resource allocation table based on the index of the dynamic indication.

For example, Table 2 is an uplink time domain resource allocation table provided in an embodiment of the present disclosure.

TABLE 2

| | PUSCH mapping | | | |
|---|---|---|---|---|
| index | type | K₂ | S | L |
| 1 | Type A | j | 0 | 14 |
| 2 | Type A | j | 0 | 12 |
| 3 | Type A | j | 0 | 10 |
| 4 | Type B | j | 2 | 10 |
| 5 | Type B | j | 4 | 10 |
| 6 | Type B | j | 4 | 8 |
| 7 | Type B | j | 4 | 6 |
| 8 | Type A | j + 1 | 0 | 14 |
| 9 | Type A | j + 1 | 0 | 12 |
| 10 | Type A | j + 1 | 0 | 10 |
| 11 | Type A | j + 2 | 0 | 14 |
| 12 | Type A | j + 2 | 0 | 12 |
| 13 | Type A | j + 2 | 0 | 10 |
| 14 | Type B | j | 8 | 6 |
| 15 | Type A | j + 3 | 0 | 14 |
| 16 | Type A | j + 3 | 0 | 10 |

A value of a parameter j in Table 2 may be obtained by querying Table 3.

TABLE 3

| μ | J |
|---|---|
| 0 | 1 |
| 1 | 1 |
| 2 | 2 |
| 3 | 3 |

As illustrated in Table 3, there is a correspondence between a value of μ and a subcarrier spacing of a BWP (carrier bandwidth part) where current communication is located. The value of μ may be determined based on this correspondence and the subcarrier spacing of the BWP where the current communication is located. The correspondence may be that: when the subcarrier spacing is 15 KHZ, then μ=0, when the subcarrier spacing is 30 KHZ, then μ=1; when the subcarrier spacing is 60 KHZ, then μ=2; when the subcarrier spacing is 120 KHZ, then μ=3. And, in an embodiment of the present disclosure, the correspondence between the value of μ and the subcarrier spacing of the BWP where the current communication is located may be transmitted from the base station to the UE through the RRC high-layer signaling.

Combining Table 2 and Table 3, there may include a plurality of indexes, and different indexes correspond to different time domain resources. Specifically, a time domain resource corresponding to index=4 includes that: the PUSCH mapping type is Type B, K₂=j, the start symbol position for data communication in the special slot is S=2, and the symbol length for data communication in the special slot is L=10.

Based on this, in an embodiment of the present disclosure, assuming that the index value of the dynamic indication of the base station is 4, the UE may directly determine the PUSCH mapping type, the symbol length for data communication in the special slot, or the start symbol position for data communication in the special slot based on the parameter.

In another embodiment of the present disclosure, the method for acquiring the number of DMRS ports or whether to enable intra-slot frequency hopping in the parameter includes: obtaining the number of DMRS ports or whether to enable intra-slot frequency hopping dynamically indicated by the base station.

It should be noted that, in an embodiment of the present disclosure, the base station always dynamically indicates to disable the intra-slot frequency hopping.

It should be noted that, in an embodiment of the present disclosure, the base station does not perform a frequency hopping configuration.

Based on the above content, the UE may successfully acquire the parameter configured and/or indicated by the base station.

Furthermore, in an embodiment of the present disclosure, when acquiring the parameter configured and/or indicated by the base station, the UE may determine the symbol resource for uplink TBoMS communication in the special slot based on the parameter. Specifically, in an embodiment of the present disclosure, a method for determining the symbol resource for uplink TBoMS communication in the special slot may include: determining a symbol numbered [S, S+L−1] in the special slot as the symbol resource for uplink TBoMS communication.

Furthermore, it should be noted that, in an embodiment of the present disclosure, for different PUSCH mapping types, start symbol positions and symbol lengths are also different.

Specifically, in an embodiment of the present disclosure, when the PUSCH mapping type is type A, the start symbol position S allocated by the base station should be a position of the 0th symbol, i.e. S=symbol #0, and the symbol length may be between [4,14], i.e. LE [4,14]. For example, assuming that the PUSCH mapping type is type A, the start symbol position S is symbol #0, and the symbol length may be 5. Therefore, it may be determined that the symbol resources for uplink TBoMS communication allocated by the base station are symbol #0-symbol #4 in the special slot.

In another embodiment of the present disclosure, when the PUSCH mapping type is type B, the start symbol position allocated by the base station is S∈[symbol #0, symbol #13], the symbol length L may be between [1,14], that is, LE [1,14], and S+L≤14. For example, assuming that the PUSCH mapping type is type B, the start symbol position S may be symbol #2, and the symbol length may be 5. Therefore, it can be determined that the symbol resources for uplink TBoMS communication allocated by the base station are symbol #2-symbol #6 in the special slot.

Furthermore, in an embodiment of the present disclosure, the UE may further determine the at least one first DMRS symbol offset value based on the parameter, in which, the first DMRS symbol offset value is specifically configured to determine a position of the DMRS symbol in the special slot.

In an embodiment of the present disclosure, when values corresponding to the parameters included in the parameters are different, the method for determining the at least one first DMRS symbol offset value based on the parameter by the UE is also different.

Specifically, in an embodiment of the present disclosure, in response to a PUSCH time domain type comprised in the parameter being a type B, the UE may determine the at least one first DMRS symbol offset value according to a mapping rule of the type B.

In another embodiment of the present disclosure, in response to a PUSCH time domain type included in the parameter is a type A, the UE may determine the at least one first DMRS symbol offset value according to a mapping rule of the type A or a type B.

In another embodiment of the present disclosure, the UE may determine the at least one first DMRS symbol offset value according to a mapping rule of a type B in response to a PUSCH time domain type included in the parameter being a type A, the number of DMRS ports being single, and a number of available symbols in the special slot being less than 4.

At step 102, a first time domain position of the DMRS is determined based on a first available symbol in the symbol resource and the at least one first DMRS symbol offset value.

In an embodiment of the present disclosure, determining the first time domain position of the DMRS based on the first available symbol in the symbol resource and the at least one first DMRS symbol offset value includes: determining a sum of a symbol numeral of the first available symbol in the symbol resource and each of the first DMRS symbol offset values to obtain at least one first sum value; and determining a symbol corresponding to a symbol numeral and each first sum value as the first time domain position of the DMRS.

In summary, in the method for configuring the time domain position of the reference signal provided in embodiments of the present disclosure, the UE may determine the available symbol in the special slot, acquire the parameter configured and/or indicated by the base station, and determine the symbol resource for data communication in the special slot and the at least one first DMRS symbol offset value based on the parameter configured and/or indicated by the base station. Afterwards, the UE determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

FIG. 2 is a flowchart illustrating a method for configuring a time domain position of a reference signal according to another embodiment of the present disclosure. The method is performed by a UE. As illustrated in FIG. 2, the method for configuring the time domain position of the reference signal may include the following steps.

At step 201, an available symbol in a special slot is determined, a parameter configured and/or indicated by a base station is acquired, a PUSCH time domain type included in the parameter is a type B, and a symbol resource for data communication in the special slot is determined based on the parameter, and at least one first DMRS symbol offset value is determined based on a mapping rule of the type B.

The detailed introduction of the available symbol, the parameter, and the symbol resource can refer to the relevant introduction in the above embodiment. Embodiments of the present disclosure will not repeat these herein.

In an embodiment of the present disclosure, the method of determining the at least one first DMRS symbol offset value based on the mapping rule of the type B may include the following method.

Method 1: the at least one first DMRS symbol offset value is determined based on a number of available symbols in the symbol resource and other parameters in the parameters other than the symbol length for data communication in the special slot.

Method 2: the at least one first DMRS symbol offset value is determined based on the symbol length for data communication in the special slot and other parameters in the parameters other than the symbol length for data communication in the special slot.

Furthermore, a detailed introduction to the above mentioned Method 1 and Method 2 is provided.

First, in an embodiment of the present disclosure, when determining at least one first DMRS symbol offset value using the Method 1 and the Method 2, it is required to utilize a PUSCH DMRS position table, where Table 4 is a PUSCH DMRS position table provided in an embodiment of the present disclosure. The UE may obtain the at least one first DMRS symbol offset value based on the parameter by querying Table 4.

TABLE 4

| | DM-RS positions l̅ | | | | | | | |
|---|---|---|---|---|---|---|---|---|
| | PUSCH mapping Type A | | | | PUSCH mapping Type B | | | |
| | DMRS-Additional Position | | | | DMRS-Additional Position | | | |
| l_{d} in symbols | pos0 | pos1 | pos2 | pos3 | pos0 | pos1 | pos2 | pos3 |
| <4 | — | — | — | — | l₀ | l₀ | l₀ | l₀ |
| 4 | l₀ | l₀ | l₀ | l₀ | l₀ | l₀ | l₀ | l₀ |
| 5 | l₀ | l₀ | l₀ | l₀ | l₀ | l₀, 4 | l₀, 4 | l₀, 4 |
| 6 | l₀ | l₀ | l₀ | l₀ | l₀ | l₀, 4 | l₀, 4 | l₀, 4 |
| 7 | l₀ | l₀ | l₀ | l₀ | l₀ | l₀, 4 | l₀, 4 | l₀, 4 |
| 8 | l₀ | l₀, 7 | l₀, 7 | l₀, 7 | l₀ | l₀, 6 | l₀, 3, 6 | l₀, 3, 6 |
| 9 | l₀ | l₀, 7 | l₀, 7 | l₀, 7 | l₀ | l₀, 6 | l₀, 3, 6 | l₀, 3, 6 |
| 10 | l₀ | l₀, 9 | l₀, 6, 9 | l₀, 6, 9 | l₀ | l₀, 8 | l₀, 4, 8 | l₀, 3, 6, 9 |
| 11 | l₀ | l₀, 9 | l₀, 6, 9 | l₀, 6, 9 | l₀ | l₀, 8 | l₀, 4, 8 | l₀, 3, 6, 9 |
| 12 | l₀ | l₀, 9 | l₀, 6, 9 | l₀, 5, 8, 11 | l₀ | l₀, 10 | l₀, 5, 10 | l₀, 3, 6, 9 |
| 13 | l₀ | l₀, 11 | l₀, 7, 11 | l₀, 5, 8, 11 | l₀ | l₀, 10 | l₀, 5, 10 | l₀, 3, 6, 9 |
| 14 | l₀ | l₀, 11 | l₀, 7, 11 | l₀, 5, 8, 11 | l₀ | l₀, 10 | l₀, 5, 10 | l₀, 3, 6, 9 |

In an embodiment of the present disclosure, l_{d} may be the number of available symbols in the symbol resource. In another embodiment of the present disclosure, l_{d} may be the symbol length for data communication in the special slot. Based on this, the UE may determine the at least one first DMRS symbol offset value based on l_{d}, the PUSCH mapping type, and the DMRS-additional position. For example, when l_{d}=10, the PUSCH mapping type is Type B, and the DMRS-additional position=pos2, it may be determined that the at least one DMRS symbol offset value is l₀, 4, and 8 by querying Table 4.

It should be noted that in an embodiment of the present disclosure, l₀ is determined based on the PUSCH mapping type. Specifically, when the PUSCH mapping type is Type A, l₀=DMRS-type A Position. When the PUSCH mapping type is Type B, l₀=0. On this basis, in this embodiment (i.e. the embodiment corresponding to FIG. 2), since it is mapped based on the mapping rule of Type B, l₀=0.

On this basis, in an embodiment of the present disclosure, when determining the at least one first DMRS symbol offset value by using Method 1, l_{d} in the above Table 4 is the number of available symbols in the symbol resource. Furthermore, the step for determining, by the UE, the at least one first DMRS symbol offset value by using Method 1 may include querying the above Table 4 based on the number of available symbols in the symbol resource, the DMRS-additional position, and the PUSCH mapping Type B to perform DMRS symbol mapping and determining the at least one first DMRS symbol offset value.

In another embodiment of the present disclosure, when determining the at least one first DMRS symbol offset value by using Method 2, l_{d} in the above Table 4 is the symbol length for data communication in the special slot. Furthermore, the step for determining, by the UE, the at least one first DMRS symbol offset value by using Method 2 may include querying the above Table 4 based on the number symbol length for data communication in the special slot, the DMRS-additional position, and the PUSCH mapping Type B to perform the DMRS symbol mapping and determining the at least one first DMRS symbol offset value.

At step 202, a first time domain position of the DMRS is determined based on a first available symbol in the symbol resource and the at least one first DMRS symbol offset value.

In an embodiment of the present disclosure, when the methods for determining the at least one first DMRS symbol offset value in step 201 are different, the methods for determining the first time domain position of the DMRS may also be different.

Specifically, when determining the at least one first DMRS symbol offset value by using Method 1, the method for determining the first time domain position of the DMRS may include: determining a sum of a symbol numeral of the first available symbol in the symbol resource and each of the first DMRS symbol offset values to obtain at least one first sum value, and determining a symbol corresponding to a symbol numeral and each first sum value as the first time domain position of the DMRS.

For example, in an embodiment of the present disclosure, it is assumed that the at least one first DMRS symbol offset value obtained by using Method 1 in step 201 is l₀, 4, 8, and the symbol numeral of the first available symbol in the symbol resource is symbol #1, the first time domain position of the DMRS determined may be symbol #(1+l₀)=symbol #(1+0)=symbol #1, symbol #(1+4)=symbol #5, symbol #(1+8)=symbol #9.

In another embodiment of the present disclosure, when determining the at least one first DMRS symbol offset value by using Method 2 in step 201, since the symbol length for data communication in the special slot is greater than the number of available symbols in the symbol resource, the determined first DMRS symbol offset value will be larger. Furthermore, when determining the first time domain position of the DMRS based on the first available symbol in the symbol resource and the at least one first DMRS symbol offset value, there may be a time domain position beyond the symbol resource in the determined first time domain position of the DMRS, which will affect data communication.

Therefore, in an embodiment of the present disclosure, when determining the at least one first DMRS symbol offset value by using Method 2 in step 201, after determining the at least one time domain position based on the first available symbol in the symbol resource and the at least one first DMRS symbol offset value, it is also required to determine a situation of whether there is a time domain position beyond the symbol resource in the at least one time domain position determined. In an embodiment of the present disclosure, when there is a time domain position beyond the symbol resource, the at least one time domain position beyond the symbol resource is discarded to obtain a remaining time domain position, and the remaining time domain position is determined as the first time domain position of the DMRS. And, in another embodiment of the present disclosure, when there is no time domain position beyond the symbol resource, the at least one time domain position determined may be determined as the first time domain position of the DMRS.

For example, assuming that at least one time domain position determined based on the first available symbol in the symbol resource and the at least one first DMRS symbol offset value may be symbol #1, symbol #5, symbol #9, and the symbol resource is symbol #1 to symbol #8. At this point, since symbol #9 is beyond the time domain position of the symbol resource, symbol #9 is discarded and symbol #1 and symbol #5 are determined as the first time domain positions of the DMRS.

In summary, in the method for configuring the time domain position of the reference signal provided in embodiments of the present disclosure, the UE may determine the available symbol in the special slot, acquire the parameter configured and/or indicated by the base station, and determine the symbol resource for data communication in the special slot and the at least one first DMRS symbol offset value based on the parameter configured and/or indicated by the base station. Afterwards, the UE determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

FIG. 3 is a flowchart illustrating a method for configuring a time domain position of a reference signal according to yet another embodiment of the present disclosure. The method is performed by a UE. As illustrated in FIG. 3, the method for configuring the time domain position of the reference signal may include the following steps.

At step 301, an available symbol in a special slot is determined, a parameter configured and/or indicated by a base station is acquired, a PUSCH time domain type included in the parameter is a type A, and a symbol resource for communication in the special slot is determined based on the parameter, and at least one first DMRS symbol offset value is determined based on a mapping rule of the type A.

The detailed introduction of the available symbol, the parameter, and the symbol resource can refer to the relevant introduction in the above embodiment. Embodiments of the present disclosure will not repeat these herein.

In an embodiment of the present disclosure, the method of determining the at least one first DMRS symbol offset value based on the mapping rule of the type A may include the following method.

Method 1: the at least one first DMRS symbol offset value is determined based on a number of available symbols in the symbol resource and other parameters in the parameters other than the symbol length for data communication in the special slot.

Method 2: the at least one first DMRS symbol offset value is determined based on the symbol length for data communication in the special slot and other parameters in the parameters other than the symbol length for data communication in the special slot.

Furthermore, a detailed introduction to the above mentioned Method 1 and Method 2 is provided.

First, in an embodiment of the present disclosure, when determining at least one first DMRS symbol offset value using the Method 1 and the Method 2, it is required to utilize a PUSCH DMRS position positioning table as illustrated in the above Table 4. The UE may obtain the at least one first DMRS symbol offset value based on the above parameter by querying Table 4.

In an embodiment of the present disclosure, l_{d} may be the number of available symbols in the symbol resource. In another embodiment of the present disclosure, l_{d} may be the symbol length for data communication in the special slot. Based on this, the UE may determine the at least one first DMRS symbol offset value based on l_{d}, the PUSCH mapping type, and the DMRS-additional position. For example, when l_{d}=10, the PUSCH mapping type is Type A, and the DMRS-additional position=pos2, it may be determined that the at least one DMRS symbol offset value is l₀, 6, and 9 by querying Table 4.

It should be noted that in an embodiment of the present disclosure, l₀ is determined based on the PUSCH mapping type. Specifically, when the PUSCH mapping type is Type A, l₀=DMRS-type A Position. When the PUSCH mapping type is Type B, l₀=0. On this basis, in this embodiment (i.e. the embodiment corresponding to FIG. 3), since it is mapped based on the mapping rule of Type B, l₀=DMRS-type A Position.

On this basis, in an embodiment of the present disclosure, when determining the at least one first DMRS symbol offset value by using Method 1, l_{d} in the above Table 4 is the number of available symbols in the symbol resource. Furthermore, the step for determining, by the UE, the at least one first DMRS symbol offset value by using Method 1 may include querying the above Table 4 based on the number of available symbols in the symbol resource, the DMRS-additional position, and the PUSCH mapping Type A to perform DMRS symbol mapping and determining the at least one first DMRS symbol offset value.

In another embodiment of the present disclosure, when determining the at least one first DMRS symbol offset value by using Method 2, l_{d} in the above Table 4 is the symbol length for data communication in the special slot. Furthermore, the step for determining, by the UE, the at least one first DMRS symbol offset value by using Method 2 may include querying the above Table 4 based on the number symbol length for data communication in the special slot, the DMRS-additional position, and the PUSCH mapping Type A to perform the DMRS symbol mapping and determining the at least one first DMRS symbol offset value.

At step 302, a first time domain position of the DMRS is determined based on a first available symbol in the symbol resource and the at least one first DMRS symbol offset value.

In an embodiment of the present disclosure, when the methods for determining the at least one first DMRS symbol offset value in step 301 are different, the methods for determining the first time domain position of the DMRS may also be different.

Specifically, when determining the at least one first DMRS symbol offset value by using Method 1, the method for determining the first time domain position of the DMRS may include: determining a sum of a symbol numeral of the first available symbol in the symbol resource and each of the first DMRS symbol offset values to obtain at least one first sum value, and determining a symbol corresponding to a symbol numeral and each first sum value as the first time domain position of the DMRS.

For example, in an embodiment of the present disclosure, it is assumed that the at least one first DMRS symbol offset value obtained by using Method 1 in step 301 is 10, 6, 9, and the symbol numeral of the first available symbol in the symbol resource is symbol #1, DMRS-typeA Position=2, the first time domain position of the DMRS determined may be symbol #(1+10)=symbol #(1+2)=symbol #3, symbol #(1+6)=symbol #7, symbol #(1+9)=symbol #10.

In another embodiment of the present disclosure, when determining the at least one first DMRS symbol offset value by using Method 2 in step 301, since the symbol length for data communication in the special slot is greater than the number of available symbols in the symbol resource, the determined first DMRS symbol offset value will be larger. Furthermore, when determining the at least one first time domain position of the DMRS based on the first available symbol in the symbol resource and the at least one first DMRS symbol offset value, there may be a time domain position beyond the symbol resource in the at least one first time domain position of the DMRS determined, which will affect data communication.

Therefore, in an embodiment of the present disclosure, when determining the at least one first DMRS symbol offset value by using Method 2 in step 301, after determining the at least one time domain position of the DMRS based on the first available symbol in the symbol resource and the at least one first DMRS symbol offset value, it is also required to determine a situation of whether there is a time domain position beyond the symbol resource in the at least one time domain position determined. In an embodiment of the present disclosure, when there is a time domain position beyond the symbol resource, the at least one time domain position beyond the symbol resource is discarded to obtain a remaining time domain position, and the remaining time domain position is determined as the first time domain position of the DMRS. And, in another embodiment of the present disclosure, when there is no time domain position beyond the symbol resource, the at least one time domain position determined may be determined as the first time domain position of the DMRS.

For example, assuming that at least one time domain position determined based on the first available symbol in the symbol resource and the at least one first DMRS symbol offset value may be symbol #3, symbol #7, symbol #10, and the symbol resource is symbol #0 to symbol #8. At this point, since symbol #10 is beyond the time domain position of the symbol resource, symbol #10 is discarded and symbol #3 and symbol #7 are determined as the first time domain positions of the DMRS.

In summary, in the method for configuring the time domain position of the reference signal provided in embodiments of the present disclosure, the UE may determine the available symbol in the special slot, acquire the parameter configured and/or indicated by the base station, and determine the symbol resource for data communication in the special slot and the at least one first DMRS symbol offset value based on the parameter configured and/or indicated by the base station. Afterwards, the UE determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

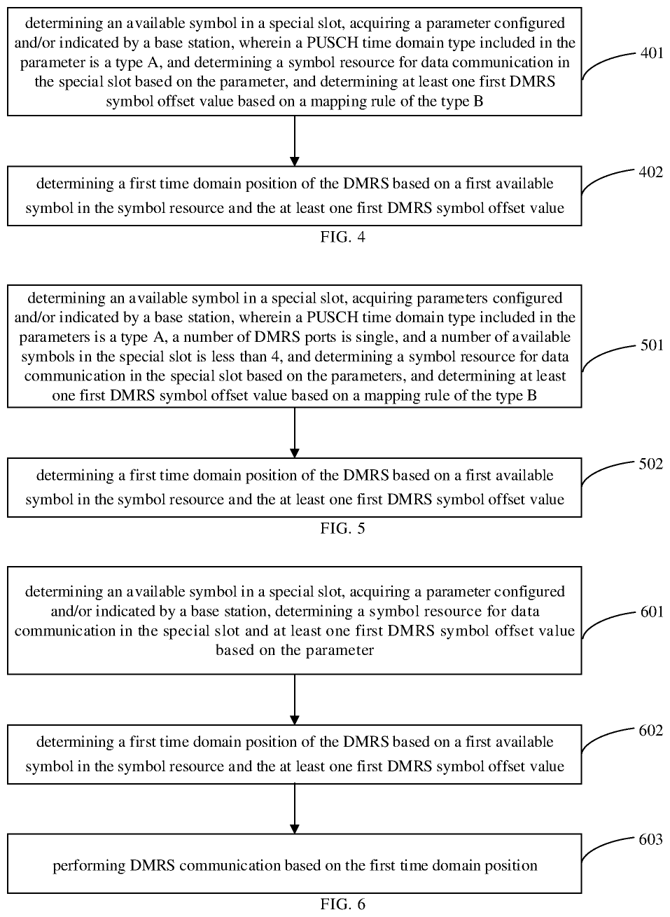

FIG. 4 is a flowchart illustrating a method for configuring a time domain position of a reference signal according to still another embodiment of the present disclosure. The method is performed by a UE. As illustrated in FIG. 4, the method for configuring the time domain position of the reference signal may include the following steps.

At step 401, an available symbol in a special slot is determined, a parameter configured and/or indicated by a base station is acquired, a PUSCH time domain type included in the parameter is a type A, and a symbol resource for data communication in the special slot is determined based on the parameter, and at least one first DMRS symbol offset value is determined based on a mapping rule of the type B.

The detailed introduction of the available symbol, the parameter, and the symbol resource can refer to the relevant introduction in the above embodiment. Embodiments of the present disclosure will not repeat these herein.

The detailed introduction to determining the at least one first DMRS symbol offset value according to the mapping rule of type B may refer to the relevant introduction in the above embodiments. Embodiments of the present disclosure will not repeat these herein.

At step 402, a first time domain position of the DMRS is determined based on a first available symbol in the symbol resource and the at least one first DMRS symbol offset value.

The detailed introduction of step 402 may refer to the relevant introduction in the above embodiments. Embodiments of the present disclosure will not repeat these herein.

In summary, in the method for configuring the time domain position of the reference signal provided in embodiments of the present disclosure, the UE may determine the available symbol in the special slot, acquire the parameter configured and/or indicated by the base station, and determine the symbol resource for data communication in the special slot and the at least one first DMRS symbol offset value based on the parameter configured and/or indicated by the base station. Afterwards, the UE determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

FIG. 5 is a flowchart illustrating a method for configuring a time domain position of a reference signal according to still another embodiment of the present disclosure. The method is performed by a UE. As illustrated in FIG. 5, the method for configuring the time domain position of the reference signal may include the following steps.

At step 501, an available symbol in a special slot is determined, parameters configured and/or indicated by a base station is acquired, a PUSCH time domain type included in the parameters is a type A, a number of DMRS ports is single, and a number of available symbols in the special slot is less than 4, and a symbol resource for data communication in the special slot is determined based on the parameters, and at least one first DMRS symbol offset value is determined based on a mapping rule of the type B.

The detailed introduction of the available symbol, the parameters, and the symbol resource can refer to the relevant introduction in the above embodiment. Embodiments of the present disclosure will not repeat these herein.

In an embodiment of the present disclosure, when the PUSCH time domain type is type A, the number of DMRS ports is single, and the number of available symbols in the special slot is less than 4, a cause for determining the at least one first DMRS symbol offset value according to the mapping rule of type B mainly includes that: Table 4 is mainly a positioning table for single DMRS symbol. Referring to Table 4, for type A, when l_{d} is less than 4, there is no corresponding DMRS symbol offset value (i.e. it cannot be determined the DMRS symbol offset value), it is required to successfully determine the at least one DMRS symbol offset value by using the mapping rule of type B.

The detailed introduction to determining the at least one first DMRS symbol offset value according to the mapping rule of type B may refer to the relevant introduction in the above embodiments. Embodiments of the present disclosure will not repeat these herein.

At step 502, a first time domain position of the DMRS is determined based on a first available symbol in the symbol resource and the at least one first DMRS symbol offset value.

The detailed introduction of step 502 may refer to the relevant introduction in the above embodiments. Embodiments of the present disclosure will not repeat these herein.

In summary, in the method for configuring the time domain position of the reference signal provided in embodiments of the present disclosure, the UE may determine the available symbol in the special slot, acquire the parameter configured and/or indicated by the base station, and determine the symbol resource for data communication in the special slot and the at least one first DMRS symbol offset value based on the parameter configured and/or indicated by the base station. Afterwards, the UE determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

FIG. 6 is a flowchart illustrating a method for configuring a time domain position of a reference signal according to still another embodiment of the present disclosure. The method is performed by a UE. As illustrated in FIG. 6, the method for configuring the time domain position of the reference signal may include the following steps.

At step 601, an available symbol in a special slot is determined, a parameter configured and/or indicated by a base station is acquired, and a symbol resource for data communication in the special slot and at least one first DMRS symbol offset value are determined based on the parameter.

At step 602, a first time domain position of the DMRS is determined based on a first available symbol in the symbol resource and the at least one first DMRS symbol offset value.

In an embodiment of the present disclosure, the detailed introduction of steps 601-602 may refer to the relevant introduction in the above embodiments. Embodiments of the present disclosure will not repeat these herein.

At step 603, the DMRS communication is performed based on the first time domain position

In summary, in the method for configuring the time domain position of the reference signal provided in embodiments of the present disclosure, the UE may determine the available symbol in the special slot, acquire the parameter configured and/or indicated by the base station, and determine the symbol resource for data communication in the special slot and the at least one first DMRS symbol offset value based on the parameter configured and/or indicated by the base station. Afterwards, the UE determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

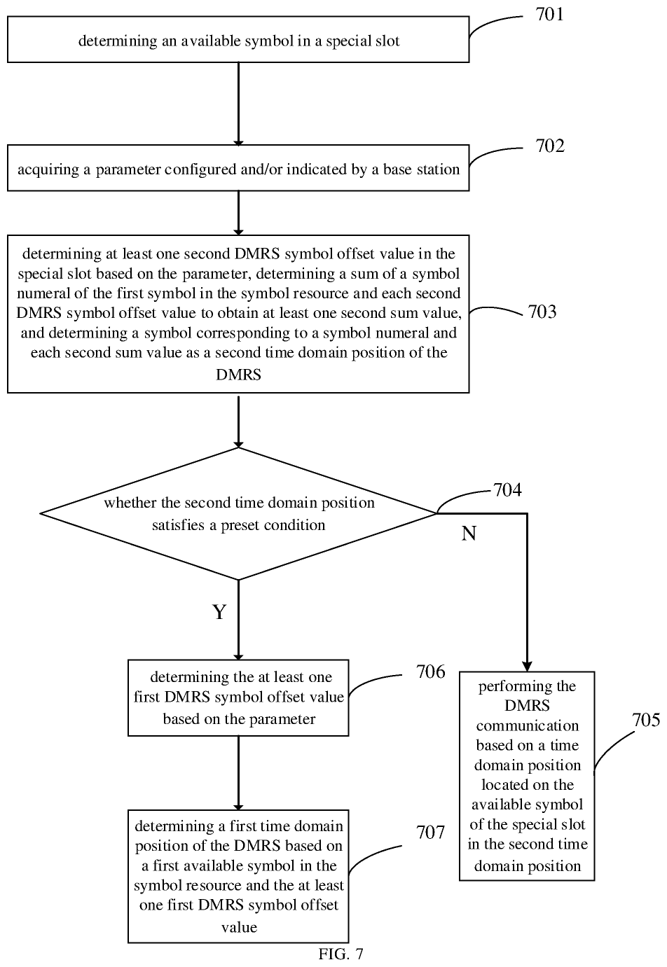

FIG. 7 is a flowchart illustrating a method for configuring a time domain position of a reference signal according to still another embodiment of the present disclosure. The method is performed by a UE. As illustrated in FIG. 7, the method for configuring the time domain position of the reference signal may include the following steps.

At step 701, an available symbol in a special slot is determined.

At step 702, a parameter configured and/or indicated by a base station is acquired.

In an embodiment of the present disclosure, the detailed introduction of steps 701-702 may refer to the relevant introduction in the above embodiments. Embodiments of the present disclosure will not repeat these herein.

At step 703, at least one second DMRS symbol offset value in the special slot is determined based on the parameter, a sum of a symbol numeral of the first symbol in the symbol resource and each second DMRS symbol offset value is determined to obtain at least one second sum value, and a symbol corresponding to a symbol numeral and each second sum value is determined as a second time domain position of the DMRS.

In an embodiment of the present disclosure, the UE may obtain the at least one second DMRS symbol offset value based on the parameter by querying the above Table 4, and when determining the second DMRS symbol offset value, l_{d} in Table 4 is a symbol length for data communication in the special slot. Furthermore, the method for determining the second DMRS symbol offset value is similar in principle to the method for determining the first DMRS symbol offset value, which may specifically refer to the description of the above embodiments. Embodiments of the present disclosure will not repeat these herein.

In an embodiment of the present disclosure, when determining the at least one second DMRS symbol offset value, determining the time domain position of the DMRS in the special slot may be determined through a conventional method first. Specifically, it can perform the above step 703 of “determining a sum of a symbol numeral of the first symbol in the symbol resource and each second DMRS symbol offset value to obtain at least one second sum value, and determining a symbol corresponding to a symbol numeral and each second sum value as a second time domain position of the DMRS”. The second time domain position is the time domain position of the DMRS in the special slot determined by using the conventional method.

At step 704, it is determined whether the second time domain position satisfies a preset condition. When the preset condition is satisfied, step 706 is executed; when the preset condition is not satisfied, step 705 is executed.

The preset condition includes at least one of:
condition one: the second time domain position conflicting with an unavailable symbol in the special slot;
condition two: the second time domain position being not located on the available symbol.

In an embodiment of the present disclosure, the preset condition may include any one of the above conditions. In another embodiment of the present disclosure, the preset condition may include both of the above conditions. In an embodiment of the present disclosure, when the preset condition includes both of the above conditions, the second time domain position satisfying any one of the preset conditions means that the preset condition is satisfied.

In an embodiment of the present disclosure, when the second time domain position satisfies the preset condition, it indicates that the second time domain position determined by the conventional method cannot be used for uplink TBoMS communication, and it is required to execute step 706 to re-determine the time domain position of the DMRS. When the second time domain position does not satisfy the preset condition, it indicates that there is a time domain position that can be used for uplink TBoMS communication in the second time domain position. Therefore, step 705 may be executed.

At step 705, the DMRS communication is performed based on a time domain position located on the available symbol of the special slot in the second time domain position.

Assuming that the unavailable symbols for the special slot are symbol #0-symbol #2, and the determined second time domain positions are symbol #1, symbol #5, and symbol #9. Then the DMRS communication can be performed based on symbol #5 and symbol #9.

At step 706, the at least one first DMRS symbol offset value is determined based on the parameter.

At step 707, a first time domain position of the DMRS is determined based on a first available symbol in the symbol resource and the at least one first DMRS symbol offset value.

The detailed introduction of steps 706-707 may refer to the relevant introduction in the above embodiments. Embodiments of the present disclosure will not repeat these herein.

In summary, in the method for configuring the time domain position of the reference signal provided in embodiments of the present disclosure, the UE may determine the available symbol in the special slot, acquire the parameter configured and/or indicated by the base station, and determine the symbol resource for data communication in the special slot and the at least one first DMRS symbol offset value based on the parameter configured and/or indicated by the base station. Afterwards, the UE determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

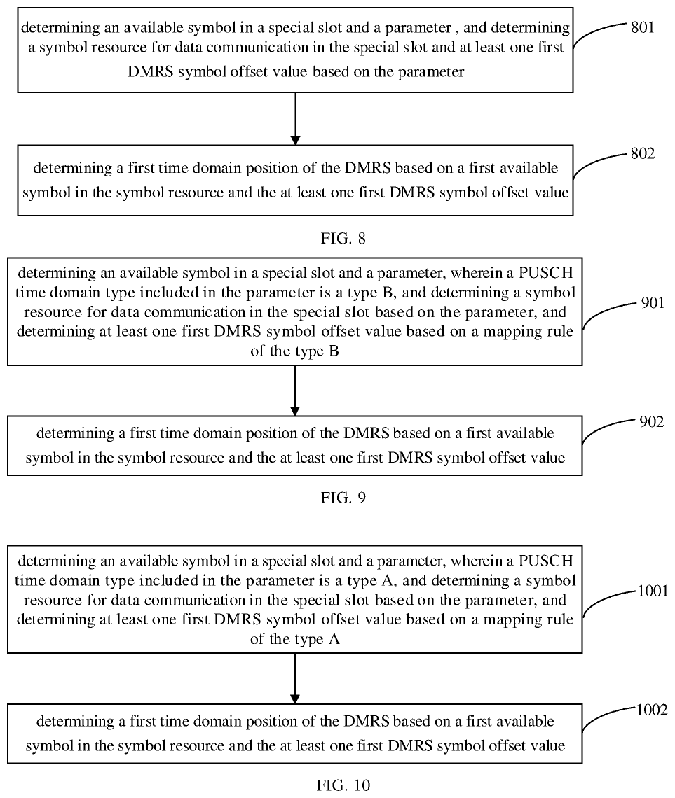

FIG. 8 is a flowchart illustrating a method for configuring a time domain position of a reference signal according to still another embodiment of the present disclosure. The method is performed by a base station. As illustrated in FIG. 8, the method for configuring the time domain position of the reference signal may include the following steps.

At step 801, an available symbol in a special slot and a parameter are determined, and a symbol resource for data communication in the special slot and at least one first DMRS symbol offset value are determined based on a parameter configured and/or indicated by a base station.

In an embodiment of the present disclosure, the method for configuring the time domain position of the reference signal of embodiments of the present disclosure is applied in a scenario where intra-slot frequency hopping is disabled.

In an embodiment of the present disclosure, determining the available symbol in the special slot may include: determining an unavailable symbol from the special slot based on a SFI dynamic indication signaling and/or a semi-persistent slot format configuration signaling sent by the base station; determining a symbol in the special slot other than the unavailable symbol as the available symbol.

In an embodiment of the present disclosure, the unavailable symbol includes at least one of:
a guard interval symbol used by downlink to uplink conversion;
a downlink symbol for downlink communication;
a symbol for SSB communication;
a symbol allocated to a CSS (e.g. CSS #0);
a symbol occupied by a CI indication; or
a symbol used for business communication with a higher priority than current data communication.

In an embodiment of the present disclosure, when a symbol in the special slot satisfies any of the above conditions, it is that the symbol is the unavailable symbol.

Further, in an embodiment of the present disclosure, the above parameter may include at least one of:
a PUSCH mapping type, in which, in an embodiment of the present disclosure, the PUSCH mapping type includes a type A and a type B;
a symbol length for data communication in the special slot;
a start symbol position for data communication in the special slot;
a DMRS-additional position;
a number of DMRS ports;
whether to enable intra-slot frequency hopping; or
a DMRS-type A position.

It should be noted that, in an embodiment of the present disclosure, the DMRS-type A Position parameter is a parameter for PUSCH mapping type A. Based on this, when the PUSCH mapping type is type B, the DMRS-type A Position parameter is invalid, and when the PUSCH mapping type is type A, the DMRS-type A Position parameter is valid.

In an embodiment of the present disclosure, the UE may determine whether a symbol type of the DMRS is a single symbol DMRS or a double symbol DMRS by querying the above Table 1 based on a configuration type of the DMRS and the number of DMRS ports in the above parameter. In an embodiment of the present disclosure, the configuration type of the DMRS may be configured to the UE by the base station through a RRC (radio resource control) high-layer parameter. Furthermore, in an embodiment of the present disclosure, the configuration type of the DMRS includes a type 1 and a type 2.

In an embodiment of the present disclosure, the method of determining a single symbol DMRS or a double symbol DMRS by the base station is consistent with the method of determining a single symbol DMRS or a double symbol DMRS by the UE, which may refer to the description of the above embodiments. The embodiments of the present disclosure will not further repeat herein.

In an embodiment of the present disclosure, the base station may configure and/or indicate the parameter to the UE. The detailed introduction of configuring and/or indicating the parameter to the UE by the base station may refer to the relevant introduction in the above embodiments. Embodiments of the present disclosure will not repeat these herein.

The detailed method of determining the symbol resource for data communication in the special slot and the at least one first DMRS symbol offset value based on the parameter may refer to the above description. Embodiments of the present disclosure will not repeat these herein.

At step 802, a first time domain position of the DMRS is determined based on a first available symbol in the symbol resource and the at least one first DMRS symbol offset value.

In an embodiment of the present disclosure, determining the first time domain position of the DMRS based on the first available symbol in the symbol resource and the at least one first DMRS symbol offset value may include: determining a sum of a symbol numeral of the first available symbol in the symbol resource and each of the first DMRS symbol offset values to obtain at least one first sum value; and determining a symbol corresponding to a symbol numeral and each first sum value as the first time domain position of the DMRS.

In summary, in the method for configuring the time domain position of the reference signal provided in embodiments of the present disclosure, the base station may determine the symbol resource for data communication in the special slot, the available symbol in the special slot, and the parameter, and determine the at least one first DMRS symbol offset value based on the parameter. Afterwards, the base station determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

FIG. 9 is a flowchart illustrating a method for configuring a time domain position of a reference signal according to still another embodiment of the present disclosure. The method is performed by a base station. As illustrated in FIG. 9, the method for configuring the time domain position of the reference signal may include the following steps.

At step 901, an available symbol in a special slot and a parameter are determined, a PUSCH time domain type included in the parameter is a type B, and a symbol resource for data communication in the special slot is determined based on the parameter, and at least one first DMRS symbol offset value is determined based on a mapping rule of the type B.

At step 902, a first time domain position of the DMRS is determined based on a first available symbol in the symbol resource and the at least one first DMRS symbol offset value.

The detailed introduction of steps 901-902 may refer to the relevant introduction in the above embodiments. Embodiments of the present disclosure will not repeat these herein.

In summary, in the method for configuring the time domain position of the reference signal provided in embodiments of the present disclosure, the base station may determine the symbol resource for data communication in the special slot, the available symbol in the special slot, and the parameter, and determine the at least one first DMRS symbol offset value based on the parameter. Afterwards, the base station determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

FIG. 10 is a flowchart illustrating a method for configuring a time domain position of a reference signal according to still another embodiment of the present disclosure. The method is performed by a base station. As illustrated in FIG. 10, the method for configuring the time domain position of the reference signal may include the following steps.

At step 1001, an available symbol in a special slot and a parameter are determined, a PUSCH time domain type included in the parameter is a type A, and a symbol resource for data communication in the special slot is determined based on the parameter, and at least one first DMRS symbol offset value is determined based on a mapping rule of the type A.

At step 1002, a first time domain position of the DMRS is determined based on a first available symbol in the symbol resource and the at least one first DMRS symbol offset value.

The detailed introduction of steps 1001-1002 may refer to the relevant introduction in the above embodiments. Embodiments of the present disclosure will not repeat these herein.

In summary, in the method for configuring the time domain position of the reference signal provided in embodiments of the present disclosure, the base station may determine the symbol resource for data communication in the special slot, the available symbol in the special slot, and the parameter, and determine the at least one first DMRS symbol offset value based on the parameter. Afterwards, the base station determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

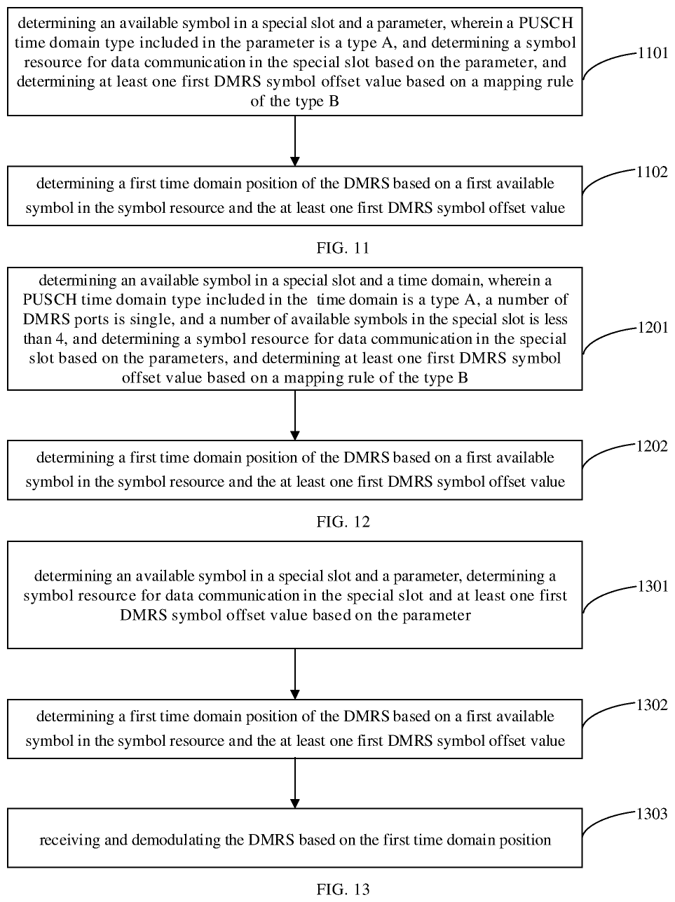

FIG. 11 is a flowchart illustrating a method for configuring a time domain position of a reference signal according to still another embodiment of the present disclosure. The method is performed by a base station. As illustrated in FIG. 11, the method for configuring the time domain position of the reference signal may include the following steps.

At step 1101, an available symbol in a special slot and a parameter are determined, a PUSCH time domain type included in the parameter is a type A, and a symbol resource for data communication in the special slot is determined based on the parameter, and at least one first DMRS symbol offset value is determined based on a mapping rule of the type B.

At step 1102, a first time domain position of the DMRS is determined based on a first available symbol in the symbol resource and the at least one first DMRS symbol offset value.

The detailed introduction of steps 1101-1102 may refer to the relevant introduction in the above embodiments. Embodiments of the present disclosure will not repeat these herein.

In summary, in the method for configuring the time domain position of the reference signal provided in embodiments of the present disclosure, the base station may determine the symbol resource for data communication in the special slot, the available symbol in the special slot, and the parameter, and determine the at least one first DMRS symbol offset value based on the parameter. Afterwards, the base station determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

FIG. 12 is a flowchart illustrating a method for configuring a time domain position of a reference signal according to still another embodiment of the present disclosure. The method is performed by a base station. As illustrated in FIG. 12, the method for configuring the time domain position of the reference signal may include the following steps.

At step 1201, an available symbol in a special slot and a parameter are determined, a PUSCH time domain type included in the parameter is a type A, the number of DMRS ports is single, and a number of available symbols in the special slot is less than 4, and a symbol resource for data communication in the special slot is determined based on the parameter, and at least one first DMRS symbol offset value is determined based on a mapping rule of the type B.

At step 1202, a first time domain position of the DMRS is determined based on a first available symbol in the symbol resource and the at least one first DMRS symbol offset value.

The detailed introduction of steps 1201-1202 may refer to the relevant introduction in the above embodiments. Embodiments of the present disclosure will not repeat these herein.

In summary, in the method for configuring the time domain position of the reference signal provided in embodiments of the present disclosure, the base station may determine the symbol resource for data communication in the special slot, the available symbol in the special slot, and the parameter, and determine the at least one first DMRS symbol offset value based on the parameter. Afterwards, the base station determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

FIG. 13 is a flowchart illustrating a method for configuring a time domain position of a reference signal according to still another embodiment of the present disclosure. The method is performed by a base station. As illustrated in FIG. 13, the method for configuring the time domain position of the reference signal may include the following steps.

At step 1301, an available symbol in a special slot and a parameter are determined, and a symbol resource for data communication in the special slot and at least one first DMRS symbol offset value are determined based on the parameter.

At step 1302, a first time domain position of the DMRS is determined based on a first available symbol in the symbol resource and the at least one first DMRS symbol offset value.

The detailed introduction of steps 1301-1302 may refer to the relevant introduction in the above embodiments. Embodiments of the present disclosure will not repeat these herein.

At step 1303, the DMRS is received and demodulated based on the first time domain position.

In summary, in the method for configuring the time domain position of the reference signal provided in embodiments of the present disclosure, the base station may determine the symbol resource for data communication in the special slot, the available symbol in the special slot, and the parameter, and determine the at least one first DMRS symbol offset value based on the parameter. Afterwards, the base station determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

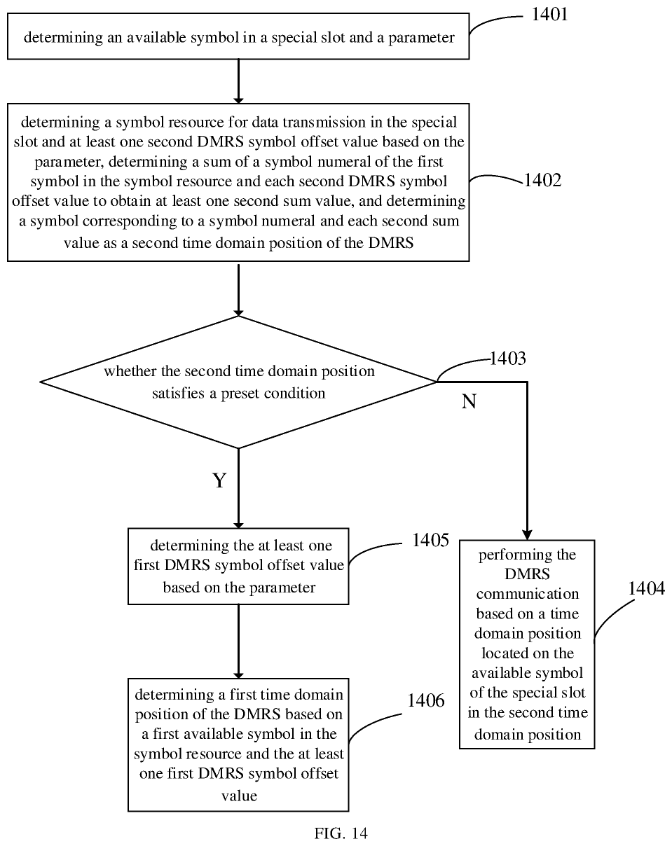

FIG. 14 is a flowchart illustrating a method for configuring a time domain position of a reference signal according to still another embodiment of the present disclosure. The method is performed by a base station. As illustrated in FIG. 14, the method for configuring the time domain position of the reference signal may include the following steps.

At step 1401, an available symbol in a special slot and a parameter are determined.

At step 1402, a symbol resource for data communication in the special slot and at least one second DMRS symbol offset value are determined based on the parameter, a sum of a symbol numeral of the first symbol in the symbol resource and each second DMRS symbol offset value is determined to obtain at least one second sum value, and a symbol corresponding to a symbol numeral and each second sum value is determined as a second time domain position of the DMRS.

At step 1403, it is determined whether the second time domain position satisfies a preset condition. When the preset condition is satisfied, step 1405 continues to be executed; when the preset condition is not satisfied, step 1404 continues to be executed.

The preset condition includes at least one of:
condition one: the second time domain position conflicting with an unavailable symbol in the special slot;
condition two: the second time domain position being not located on the available symbol.

In an embodiment of the present disclosure, the preset condition may include any one of the above conditions. In another embodiment of the present disclosure, the preset condition may include both of the above conditions. In an embodiment of the present disclosure, when the preset condition includes both of the above conditions, the second time domain position satisfying any one of the preset conditions means that the preset condition is satisfied.

At step 1404, the DMRS communication is performed based on a time domain position located on the available symbol of the special slot in the second time domain position.

At step 1405, the at least one first DMRS symbol offset value is determined based on the parameter.

At step 1406, a first time domain position of the DMRS is determined based on a first available symbol in the symbol resource and the at least one first DMRS symbol offset value.

The detailed introduction of steps 1401-1406 may refer to the relevant introduction in the above embodiments. Embodiments of the present disclosure will not repeat these herein.

In summary, in the method for configuring the time domain position of the reference signal provided in embodiments of the present disclosure, the base station may determine the symbol resource for data communication in the special slot, the available symbol in the special slot, and the parameter, and determine the at least one first DMRS symbol offset value based on the parameter. Afterwards, the base station determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

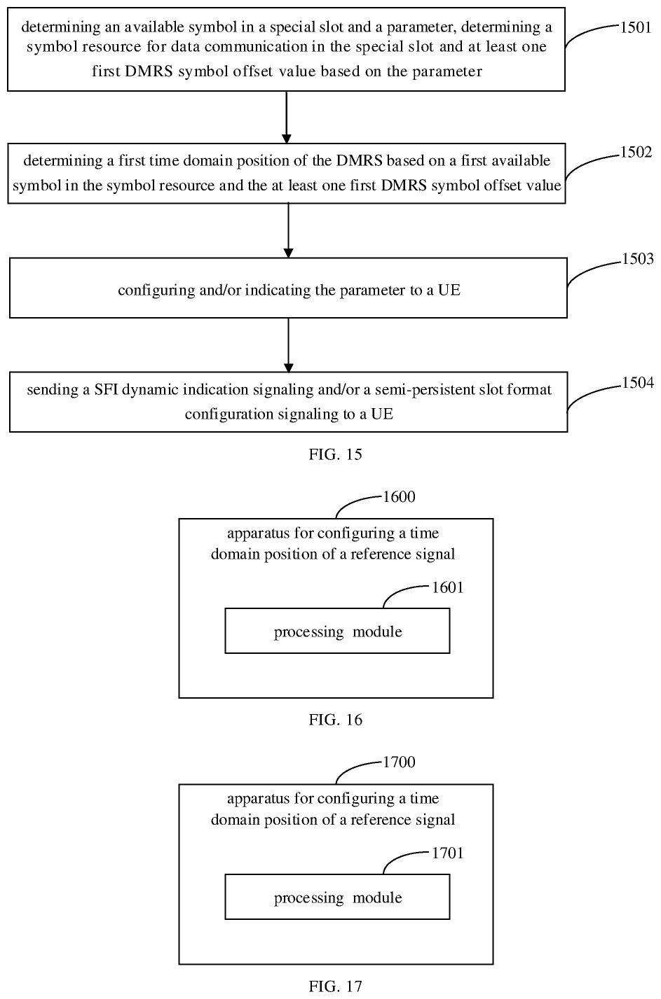

FIG. 15 is a flowchart illustrating a method for configuring a time domain position of a reference signal according to still another embodiment of the present disclosure. The method is performed by a base station. As illustrated in FIG. 15, the method for configuring the time domain position of the reference signal may include the following steps.

At step 1501, an available symbol in a special slot and a parameter are determined, and a symbol resource for data communication and at least one first DMRS symbol offset value are determined based on the parameter.

At step 1502, a first time domain position of the DMRS is determined based on a first available symbol in the symbol resource and the at least one first DMRS symbol offset value.

At step 1503, the parameter is configured and/or indicated to a UE.

The detailed introduction of steps 1501-1503 may refer to the relevant introduction in the above embodiments. Embodiments of the present disclosure will not repeat these herein.

At step 1504, a SFI dynamic indication signaling and/or a semi-persistent slot format configuration signaling is sent to a UE.

In an embodiment of the present disclosure, the base station may send the SFI dynamic indication signaling and/or the semi-persistent slot format configuration signaling to the UE, such that the UE may determine the unavailable symbol from the special slot based on the SFI dynamic indication signaling and/or the semi-persistent slot format configuration signaling sent by the base station.

In summary, in the method for configuring the time domain position of the reference signal provided in embodiments of the present disclosure, the base station may determine the symbol resource for data communication in the special slot, the available symbol in the special slot, and the parameter, and determine the at least one first DMRS symbol offset value based on the parameter. Afterwards, the base station determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

FIG. 16 is a schematic diagram illustrating a structure of an apparatus for configuring a time domain position of a reference signal according to an embodiment of the present disclosure. As illustrated in FIG. 16, the apparatus 1600 may include a processing module 1601.

The processing module 1601 is configured to determine an available symbol in a special slot, and acquire a parameter configured and/or indicated by a base station; determine a symbol resource for data communication in the special slot and at least one first demodulation reference signal (DMRS) symbol offset value based on the parameter.

The processing module 1601 is further configured to determine a first time domain position of the DMRS based on a first available symbol in the symbol resource and the at least one first DMRS symbol offset value.

In summary, in the apparatus for configuring the time domain position of the reference signal provided in embodiments of the present disclosure, the UE may determine the available symbol in the special slot, acquire the parameter configured and/or indicated by the base station, and determine the symbol resource for data communication in the special slot and the at least one first DMRS symbol offset value based on the parameter configured and/or indicated by the base station. Afterwards, the UE determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

In an embodiment of the present disclosure, the processing module 1601 is further configured to:
determine a sum of a symbol numeral of the first available symbol in the symbol resource and each of the first DMRS symbol offset values to obtain at least one first sum value; and
determine a symbol corresponding to a symbol numeral and each first sum value as the first time domain position of the DMRS.

Further, in another embodiment of the present disclosure, the processing module 1601 is further configured to:
determine an unavailable symbol from the special slot based on a slot format indicator (SFI) dynamic indication signaling and/or a semi-persistent slot format configuration signaling;
determine the available symbol to be a symbol in the special slot other than the unavailable symbol;
in which, the unavailable symbol comprises at least one of:
a guard interval symbol used by downlink to uplink conversion;
a downlink symbol for downlink communication;
a symbol for synchronization signal block (SSB) communication;
a symbol allocated to a common search space (CSS);
a symbol occupied by a communication cancel indication (CI); or
a symbol used for business communication with a higher priority than current data communication.

Further, in another embodiment of the present disclosure, the parameter includes at least one of:
a physical uplink shared channel (PUSCH) mapping type, wherein the PUSCH mapping type comprises a type A and a type B;
a symbol length for data communication in the special slot;
a start symbol position for data communication in the special slot;
a DMRS-additional position;
a number of DMRS ports;
whether to enable intra-slot frequency hopping; or
a DMRS-type A position.

Further, in another embodiment of the present disclosure, the processing module 1601 is further configured to:
in response to a PUSCH time domain type comprised in the parameter being a type B, determine the at least one first DMRS symbol offset value according to a mapping rule of the type B.

Further, in another embodiment of the present disclosure, the processing module 1601 is further configured to:
in response to a PUSCH time domain type comprised in the parameter being a type A, determine the at least one first DMRS symbol offset value according to a mapping rule of the type A or a type B.

Further, in another embodiment of the present disclosure, the processing module 1601 is further configured to:
determine the at least one first DMRS symbol offset value according to a mapping rule of a type B, in which, a PUSCH time domain type is a type A, the number of DMRS ports is single, and a number of available symbols in the special slot is less than 4.

Further, in another embodiment of the present disclosure, the processing module 1601 is further configured to:
determine the at least one first DMRS symbol offset value based on a number of available symbols in the symbol resource and other parameters in the parameters other than the symbol length for data communication in the special slot.

Further, in another embodiment of the present disclosure, the processing module 1601 is further configured to:
determine the at least one first DMRS symbol offset value based on the symbol length for data communication in the special slot and other parameters in the parameters other than the symbol length for data communication in the special slot.

Further, in another embodiment of the present disclosure, the processing module 1601 is further configured to:
determine at least one time domain position based on the position of the first available symbol in the symbol resource and the at least one first DMRS symbol offset value;
determine whether a time domain position beyond the symbol resource exists in the at least one time domain position;
in response to the time domain position beyond the symbol resource existing in the at least one time domain position, discard the time domain position beyond the symbol resource in the at least one time domain position to obtain a remaining time domain position, and determine the remaining time domain position as the first time domain position of the DMRS; and
in response to no time domain position beyond the symbol resource existing in the at least one time domain position, determine the at least one time domain position as the first time domain position of the DMRS.

Further, in another embodiment of the present disclosure, the above apparatus is further configured to:
perform the DMRS communication based on the first time domain position.

Further, in another embodiment of the present disclosure, the above apparatus is further configured to:
acquire the parameter configured and/or indicated by the base station;
determine at least one second DMRS symbol offset value in the special slot based on the parameter, determine a sum of a symbol numeral of the first symbol in the symbol resource and each second DMRS symbol offset value to obtain at least one second sum value, and determine a symbol corresponding to a symbol numeral and each second sum value as a second time domain position of the DMRS;
determine whether the second time domain position satisfies a preset condition, in which the preset condition includes at least one of: the second time domain position conflicting with an unavailable symbol in the special slot, and the second time domain position being not located on the available symbol; and
in response to the preset condition being satisfied, determine the at least one first DMRS symbol offset value based on the parameter; in response to the preset condition being not satisfied, perform the DMRS communication based on a time domain position located on the available symbol of the special slot in the second time domain position.

FIG. 17 is a schematic diagram illustrating a structure of an apparatus for configuring a time domain position of a reference signal according to an embodiment of the present disclosure. As illustrated in FIG. 17, the apparatus 1700 may include a processing module 1701.

The processing module 1701 is configured to determine an available symbol in a special slot and a parameter, and determine a symbol resource for data communication in the special slot and at least one first DMRS symbol offset value based on the parameter.

The processing module 1701 is further configured to determine a first time domain position of the DMRS based on a first available symbol in the symbol resource and the at least one first DMRS symbol offset value.

In summary, in the apparatus for configuring the time domain position of the reference signal provided in embodiments of the present disclosure, the UE may determine the available symbol in the special slot, acquire the parameter configured and/or indicated by the base station, and determine the symbol resource for data communication in the special slot and the at least one first DMRS symbol offset value based on the parameter configured and/or indicated by the base station. Afterwards, the UE determines the first time domain position of the DMRS based on the first available symbol in the symbol resource and the at least one first DMRS symbol offset value. In embodiments of the present disclosure, since the UE determines the first time domain position of the DMRS based on the first available symbol in the symbol resource and the at least one first DMRS symbol offset value, it may be ensured that the first time domain position of the DMRS determined is always an available symbol, rather than an unavailable symbol, which may ensure that the first time domain position of the DMRS can perform the DMRS communication normally, avoid a resource waste and reduce costs, and increase an encoding gain.

In an embodiment of the present disclosure, the processing module 1701 is further configured to:
determine a sum of a symbol numeral of the first available symbol in the symbol resource and each of the first DMRS symbol offset values to obtain at least one first sum value; and
determine a symbol corresponding to a symbol numeral and each first sum value as the first time domain position of the DMRS.

Further, in another embodiment of the present disclosure, the processing module 1701 is further configured to:
determine an unavailable symbol from the special slot;
determine the available symbol to be a symbol in the special slot other than the unavailable symbol;
in which, the unavailable symbol includes at least one of:
a guard interval symbol used by downlink to uplink conversion;
a downlink symbol for downlink communication;
a symbol for synchronization signal block (SSB) communication;
a symbol allocated to a CSS;
a symbol occupied by a communication cancel indication (CI); or
a symbol used for business communication with a higher priority than current data communication.

Further, in another embodiment of the present disclosure, the parameter includes at least one of:
a PUSCH mapping type, wherein the PUSCH mapping type comprises a type A and a type B;
a symbol length for data communication in the special slot;
a start symbol position for data communication in the special slot;
a DMRS-additional position;
a number of DMRS ports;
whether to enable intra-slot frequency hopping; or
a DMRS-type A position.

Further, in another embodiment of the present disclosure, the processing module 1701 is further configured to:
in response to a PUSCH time domain type comprised in the parameter being a type B, determine the at least one first DMRS symbol offset value according to a mapping rule of the type B.

Further, in another embodiment of the present disclosure, the processing module 1701 is further configured to:
in response to a PUSCH time domain type comprised in the parameter being a type A, determine the at least one first DMRS symbol offset value according to a mapping rule of the type A or a type B.

Further, in another embodiment of the present disclosure, the processing module 1701 is further configured to:
determine the at least one first DMRS symbol offset value according to a mapping rule of a type B, in which, a PUSCH time domain type is a type A, the number of DMRS ports is single, and a number of available symbols in the special slot is less than 4.

Further, in another embodiment of the present disclosure, the processing module 1701 is further configured to:
determine the at least one first DMRS symbol offset value based on a number of available symbols in the symbol resource and other parameters in the parameters other than the symbol length for data communication in the special slot.

Further, in another embodiment of the present disclosure, the processing module 1701 is further configured to:
determine the at least one first DMRS symbol offset value based on the symbol length for data communication in the special slot and other parameters in the parameters other than the symbol length for data communication in the special slot.

Further, in another embodiment of the present disclosure, the processing module 1701 is further configured to:
determine at least one time domain position based on the position of the first available symbol in the symbol resource and the at least one first DMRS symbol offset value;
determine whether a time domain position beyond the symbol resource exists in the at least one time domain position;
in response to the time domain position beyond the symbol resource existing in the at least one time domain position, discard the time domain position beyond the symbol resource in the at least one time domain position to obtain a remaining time domain position, and determine the remaining time domain position as the first time domain position of the DMRS; and
in response to no time domain position beyond the symbol resource existing in the at least one time domain position, determine the at least one time domain position as the first time domain position of the DMRS.

Further, in another embodiment of the present disclosure, the apparatus is further configured to:
receiving and demodulating the DMRS based on the first time domain position.

Further, in another embodiment of the present disclosure, the apparatus is further configured to:
determine at least one second DMRS symbol offset value in the special slot based on the parameter, determine a sum of a symbol numeral of the first symbol in the symbol resource and each second DMRS symbol offset value to obtain at least one second sum value, and determine a symbol corresponding to a symbol numeral and each second sum value as a second time domain position of the DMRS;
determine whether the second time domain position satisfies a preset condition, wherein the preset condition comprises at least one of: the second time domain position conflicting with an unavailable symbol in the special slot, and the second time domain position being not located on the available symbol; and
in response to the preset condition being satisfied, determine the at least one first DMRS symbol offset value based on the parameter; in response to the preset condition being not satisfied, perform the DMRS communication based on a time domain position located on the available symbol of the special slot in the second time domain position.

Further, in another embodiment of the present disclosure, the apparatus is further configured to:
configure and/or indicate the parameter to a UE.

Further, in another embodiment of the present disclosure, the apparatus is further configured to:
send a SFI dynamic indication signaling and/or a semi-persistent slot format configuration signaling to a UE.

An embodiment of the present disclosure provides a computer-readable storage medium having an executable program stored thereon. After the executable program is executed by the processor, any method illustrated in FIGS. 1 to 7 or FIGS. 8 to 15 can be implemented.

In order to implement the above embodiments, the present disclosure also provides a computer program product including a computer program. The computer program implements any method illustrated in FIGS. 1 to 7 or FIGS. 8 to 15 when executed by a processor.

In addition, in order to implement the above embodiments, the present disclosure also provides a computer program. The program implements any method illustrated in FIGS. 1 to 7 or FIGS. 8 to 15 when executed by a processor.

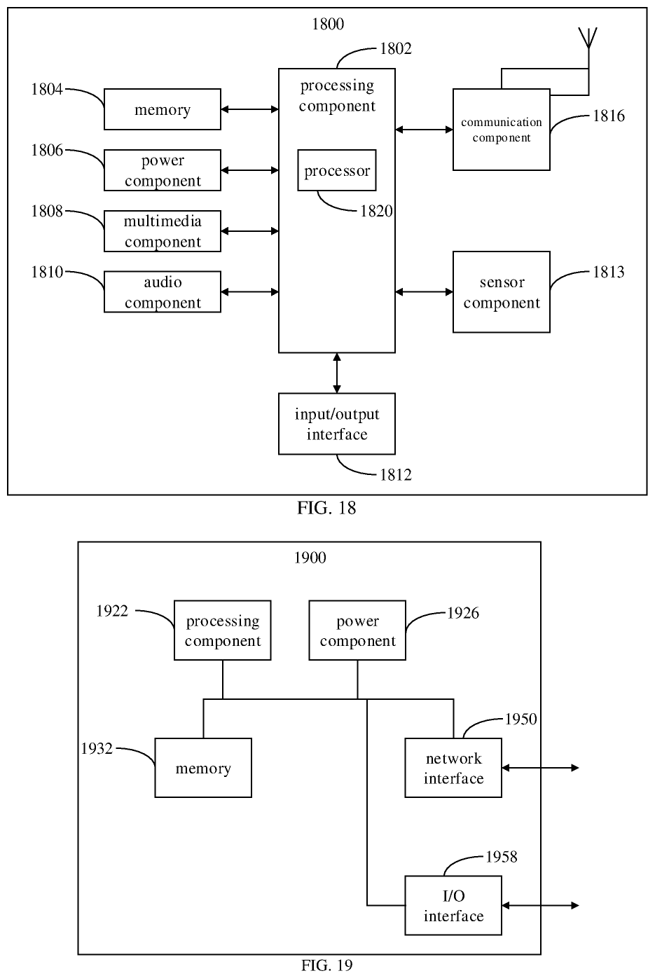

FIG. 18 is a block diagram of a user equipment (UE) 1800 provided in an embodiment of the present disclosure. For example, the UE 1800 can be a mobile phone, a computer, a digital broadcast user equipment, a messaging device, a game console, a tablet device, a medical device, a fitness device, a personal digital assistant, or the like.

Referring to FIG. 18, the UE 1800 may include at least of the following components: a processing component 1802, a memory 1804, a power component 1806, a multimedia component 1808, an audio component 1810, an input/output (I/O) interface 1812, a sensor component 1813, and a communication component 1816.

The processing component 1802 typically controls overall operations of the UE 1800, such as the operations associated with display, phone calls, data communications, camera operations, and recording operations. The processing component 1802 can include at least one processor 1820 to execute instructions to perform all or some of the steps in the above-described methods. Moreover, the processing component 1802 may include at least one module which facilitate the interaction between the processing component 1802 and other components. For instance, the processing component 1802 may include a multimedia module to facilitate the interaction between the multimedia component 1808 and the processing component 1802.

The memory 1804 is configured to store various types of data to support the operation of the UE 1800. Examples of such data include instructions for any applications or methods operated on the UE 1800, contact data, phonebook data, messages, pictures, videos, etc. The memory 1804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1806 provides power to various components of the UE 1800. The power component 1806 may include a power management system, at least one power source, and any other components associated with the generation, management, and distribution of power in the UE 1800.

The multimedia component 1808 includes a screen providing an output interface between the UE 1800 and the user. In some embodiments, the screen may include a liquid crystal display (LCD) and a touch panel (TP). If the screen includes the touch panel, the screen may be implemented as a touch screen to receive input signals from the user. The touch panel includes at least one touch sensor to sense touches, swipes, and gestures on the touch panel. The touch sensors may not only sense a boundary of a touch or swipe action, but also sense a wake up time and a pressure associated with the touch or swipe action. In some embodiments, the multimedia component 1808 includes a front camera and/or a rear camera. The front camera and/or the rear camera may receive an external multimedia datum while the user equipment 1800 is in an operation mode, such as a photographing mode or a video mode. Each of the front camera and the rear camera may be a fixed optical lens system or have focus and optical zoom capability.

The audio component 1810 is configured to output and/or input audio signals. For example, the audio component 1810 includes a microphone (MIC) configured to receive an external audio signal when the user equipment 1800 is in an operation mode, such as a call mode, a recording mode, and a voice recognition mode. The received audio signal may be further stored in the memory 1804 or transmitted via the communication component 1816. In some embodiments, the audio component 1810 further includes a speaker to output audio signals.

The I/O interface 1812 provides an interface between the processing component 1802 and peripheral interface modules, such as keyboards, click wheels, buttons, and the like. The buttons may include, but are not limited to, a home button, a volume button, a starting button, and a locking button.

The sensor component 1813 includes at least one sensor to provide status assessments of various aspects of the UE 1800. For instance, the sensor component 1813 may detect an open/closed status of the UE 1800, relative positioning of components, e.g., the display and the keypad, of the UE 1800, a change in position of the UE 1800 or a component of the UE 1800, a presence or absence of user contact with the UE 1800, an orientation or an acceleration/deceleration of the UE 1800, and a change in temperature of the UE 1800. The sensor component 1813 may include a proximity sensor configured to detect the presence of nearby objects without any physical contact. The sensor component 1813 may further include a light sensor, such as a CMOS or CCD image sensor, for use in imaging applications. In some embodiments, the sensor component 1813 may further include an accelerometer sensor, a gyroscope sensor, a magnetic sensor, a pressure sensor, or a temperature sensor.

The communication component 1816 is configured to facilitate communication, wired or wireless, between the UE 1800 and other devices. The UE 1800 can access a wireless network based on a communication standard, such as WiFi, 2G, or 3G, or a combination thereof. In an illustrative embodiment, the communication component 1816 receives a broadcast signal or broadcast associated information from an external broadcast management system via a broadcast channel. In an illustrative embodiment, the communication component 1816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an illustrative embodiment, the UE 1800 may be implemented with at least one application specific integrated circuit (ASIC), a digital signal processor (DSP), a digital signal processing device (DSPD), a programmable logic device (PLD), a field programmable gate array (FPGA), a controller, a micro-controller, a microprocessor, or other electronic elements, for performing the above-mentioned method.

FIG. 19 is a block diagram illustrating a base station 1900 according to an embodiment of the present disclosure. For example, the base station 1900 may be provided as a base station. Referring to FIG. 19, the base station 1900 includes a processing component 1911, which further includes at least one processor, and memory resources represented by a memory 1932 for storing instructions executable by the processing component 1922, such as an application program. The application program stored in the memory 1932 may include one or more modules each corresponding to a set of instructions. In addition, the processing component 1911 is configured to execute instructions to perform any one of the above-mentioned methods performed by the base station, for example, the method shown in FIG. 1.

The base station 1900 may further include a power component 1926 configured to perform power management of the base station 1900, a wired or wireless network interface 1950 configured to connect the base station 1900 to a network, and an input/output (I/O) interface 1958. The base station 1900 may operate based on an operating system stored in the memory 1932, such as Windows Server™, Mac OS X™, Unix™, Linux™, FreeBSD™, or the like.

In the above-mentioned embodiments provided in this disclosure, the methods provided in embodiments of the present disclosure are introduced from the perspectives of the base station and the UE. In order to achieve various functions of the methods provided in embodiments of the present disclosure, the base station and the UE may include a hardware structure and a software module, which are implemented in a form of hardware structure, software module, or a combination of the hardware structure and the software module. One of the above functions can be executed in the form of hardware structure, software module, or the combination of the hardware structure and the software module.

An embodiment of the present disclosure provides a communication device. The communication device may include: a transceiver module and a processing module. The transceiver module may include a sending module and/or a receiving module. The sending module is configured to implement a sending function, the receiving module is configured to implement a receiving function, and the transceiver module may implement sending and/or receiving functions.

The communication device can be a terminal device (e.g., the terminal device in the aforementioned method embodiment), a device in the terminal device, or a device that can be matched and used with the terminal device. Alternatively, the communication device can be a network device, a device in the network device, or a device that can be matched and used with the network device.

An embodiment of the present disclosure provides another communication device. The communication device may be a network device, or a terminal device (e.g., the terminal device in the aforementioned method embodiment), or a chip, a chip system, or a processor that supports the network device to implement the above method, or a chip, a chip system, or a processor that supports the terminal device to implement the above method. The device may be configured to implement the method as described in the above method embodiments, the details of which may refer to illustration of the above method embodiments.

The communication device may include one or more processors. The processor may be a general-purpose processor, a dedicated processor, or the like. For example, the processor may be a baseband processor or a central processing unit. The baseband processor may be configured to process a communication protocol and communication data, while the central processor may be configured to control the communication devices (such as a base station, a baseband chip, a terminal device, a terminal chip, a DU or a CU, etc.), execute a computer program, and process data from computer program.

Optionally, the communication device may further include one or more memories, each with a computer program stored thereon. The processor may execute the computer program to enable the communication device to execute the method as described in the above method embodiments. Optionally, the memory may further store data. The communication device and the memory may be set separately or integrated together.

Optionally, the communication device may further include a transceiver and an antenna. The transceiver may be referred to as a transceiver unit, transceiver, or transceiver circuit, etc., configured to achieve a transceiver function. The transceiver may include a receiver and a transmitter, and the receiver may be referred to as a receiver or a reception circuit, etc., configured to achieve a reception function; the transmitters may be referred to as a transmitter or a transmission circuit, etc., configured to achieve a transmission function.

Optionally, the communication device may also include one or more interface circuits. The interface circuit is configured to receive code instructions and transmit the code instructions to the processor. The processor runs the code instructions causing the communication device to execute the method as described in the above method embodiment.

The communication device is a terminal device (e.g., the terminal device in the aforementioned method embodiment). The processor is configured to perform the method as illustrated in any one of FIG. 1 to FIG. 4.

The communication device is a network device. The transceiver is configured to perform the method as illustrated in any one of FIG. 5 to FIG. 8.

In an implementation, the processor may include a transceiver for implementing reception and transmission functions. For example, the transceiver may be a transceiver circuit, an interface, or an interface circuit. The transceiver circuit, the interface, or the interface circuit for achieving the reception and transmission functions may be separate or integrated together. The above-mentioned transceiver circuit, interface or interface circuit may be configured for reading and writing codes/data, or the aforementioned transceiver circuit, interface or interface circuit may be configured for transmitting or transferring of signals.

In an implementation, the processor may store a computer program. The computer program may cause communication device to execute the method described in the above method embodiment when running on the processor. The computer program may be embedded in the processor, in which case the processor may be implemented by hardware.

In an implementation, the communication device may include a circuit that may achieve functions of sending, receiving, or communicating in the aforementioned method embodiments. The processor and the transceiver described in the present disclosure may be implemented on an integrated circuit (IC), an analog IC, a radio frequency integrated circuit (RFIC), a mixed signal IC, an application specific integrated circuits (ASIC), a printed circuit boards (PCB), an electronic device, and the like. The processor and the transceiver may also be manufactured using various IC process technologies, such as complementary metal oxide semiconductor (CMOS), N-type metal oxide semiconductor (NMOS), P-type metal oxide semiconductor (PMOS), bipolar junction transistor (BJT), bipolar CMOS (BiCMOS), silicon germanium (SiGe), gallium arsenide (GaAs), etc.

The communication device described in the above embodiments may be a network device or a terminal device (such as the terminal device in the aforementioned method embodiment), but the scope of the communication device described in the present disclosure is not limited to this, and the structure of the communication device may not be limited. The communication device can be an independent device or can be part of a larger device. For example, the communication device may be:
(1) an independent integrated circuit IC, or a chip, or a chip system or subsystem;
(2) a set of one or more ICs, optionally including a storage element for storing data and the computer program;
(3) an ASIC, such as a modem;
(4) modules that can be embedded in other devices;
(5) a receiver, a terminal, a smart terminal, a cellular phone, a wireless device, a handheld device, a mobile unit, an on-board device, a network device, a cloud device, an artificial intelligence device, etc.;
(6) others and the like.

For a case that the communication device is the chip or the chip system, the chip includes a processor and an interface. A number of processors may be one or more, and a number of interfaces may be more than one.

Optionally, the chip may further include a memory. The memory is configured to store a necessary computer program and data.

Those skilled in the art may also understand that various illustrative logical blocks and steps listed in embodiments of the present disclosure can be implemented through electronic hardware, computer software, or a combination thereof. Whether such functions are implemented through hardware or software depends on a specific application and design requirements of an overall system. Those skilled in the art may use various methods to implement functions for each specific application, but such implementation should not be understood as beyond the scope of protection of embodiments of the present disclosure.

An embodiment of the present disclosure also provides a system for determining a duration of side links, which includes a communication device as a terminal device (such as the first terminal device in the aforementioned method embodiment) and a communication device as a network device in the aforementioned embodiment, or a communication device as a terminal device (such as the first terminal device in the aforementioned method embodiment) and a communication device as a network device in the aforementioned embodiment.

The present disclosure also provides a computer-readable storage medium with instructions stored thereon. The instructions are configured to implement functions of any of the above method embodiments when executed by a computer.

The present disclosure also provides a computer program product, configured to implement functions of any of the above method embodiments when executed by a computer.

All or part of the above embodiments can be implemented through software, hardware, firmware, or any combination thereof. When implemented using the software, all or part of the above embodiments can be implemented in the form of computer program product. The computer program product includes one or more computer programs. When loading and executing the computer programs on a computer, the computer programs may be generated all or part of processes or functions according to embodiments of the present disclosure. The computer can be a general-purpose computer, a specialized computer, a computer network, or other programmable devices. The computer programs can be stored on a computer-readable storage media or transmitted from one computer readable storage medium to another, for example, the computer programs can be transmitted from a website site, a computer, a server or a data center to another website site, computer, server, or data center through wired (such as coaxial cable, fiber optic, digital subscriber line (DSL)) or wireless (such as infrared, wireless, microwave, etc.) methods. The computer-readable storage medium can be any available medium that a computer can access, or a data storage device such as a server including one or more available media integrations or a data center. The available media can be a magnetic media (such as a floppy disk, a hard drive, a magnetic tape), an optical media (such as a high-density digital video disc (DVD)), or a semiconductor media (such as a solid state disk (SSD)), etc.

Those ordinary skilled in the art may understand that first, second, and other numerical numbers involved in the disclosure are distinguished only for convenience of description, and are not intended to limit the scope of embodiments of the present disclosure, nor indicate an order.

At least one in this disclosure can also be described as one or more, and a plurality can be two, three, four, or more, without limitation in this disclosure. In embodiments of the present disclosure, for one type of technical feature, technical features in the type of technical feature are distinguished by “first”, “second”, “third”, “A”, “B”, “C”, and “D”. The technical features described by “first”, “second”, “third”, “A”, “B”, “C”, and “D” are without any order or sequence.

Other embodiments of the disclosure will be apparent to those skilled in the art from consideration of the specification and practice of the disclosure disclosed here. The present disclosure is intended to cover any variations, uses, or adaptations of the disclosure following the general principles thereof and including such departures from the present disclosure as come within known or customary practice in the art. It is intended that the specification and examples be considered as illustrative only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. A method for configuring a time domain position of a reference signal, performed by a user equipment (UE), comprising:
determining an available symbol in a special slot, and acquiring a parameter configured and/or indicated by a base station;
determining a symbol resource for data communication in the special slot and at least one first demodulation reference signal (DMRS) symbol offset value based on the parameter; and
determining a first time domain position of a DMRS based on a first available symbol in the symbol resource and the at least one first DMRS symbol offset value.

2. The method according to claim 1, wherein determining the first time domain position of the DMRS based on the first available symbol in the symbol resource and the at least one first DMRS symbol offset value comprises:
determining a sum of a symbol numeral of the first available symbol in the symbol resource and each of the at least one first DMRS symbol offset value to obtain at least one first sum value; and
determining a symbol corresponding to a symbol numeral and each of the at least one first sum value as the first time domain position of the DMRS.

3. The method according to claim 1, wherein determining the available symbol in the special slot comprises:
determining an unavailable symbol from the special slot based on a slot format indicator (SFI) dynamic indication signaling and/or a semi-persistent slot format configuration signaling;
determining the available symbol to be a symbol in the special slot other than the unavailable symbol;
wherein the unavailable symbol comprises at least one of:
a guard interval symbol used by downlink to uplink conversion;
a downlink symbol for downlink communication;
a symbol for synchronization signal block (SSB) communication;
a symbol allocated to a common search space (CSS);
a symbol occupied by a communication cancel indication (CI); or
a symbol used for business communication with a higher priority than current data communication.

4. The method according to claim 1, wherein the parameter comprises at least one of:
a physical uplink shared channel (PUSCH) mapping type, wherein the PUSCH mapping type comprises a type A and a type B;
a symbol length for data communication in the special slot;
a start symbol position for data communication in the special slot;
a DMRS-additional position;
a number of DMRS ports;
whether to enable intra-slot frequency hopping; or
a front-loaded DMRS-type A position.

5. The method according to claim 4, wherein determining the at least one first demodulation reference signal (DMRS) symbol offset value based on the parameter configured and/or indicated by the base station comprises one of:
determining the at least one first DMRS symbol offset value according to a mapping rule of a type B, wherein a PUSCH time domain type comprised in the parameter is the type B;
determining the at least one first DMRS symbol offset value according to a mapping rule of a type A or a type B, wherein a PUSCH time domain type comprised in the parameter is the type A; or
determining the at least one first DMRS symbol offset value according to a mapping rule of a type B, wherein a PUSCH time domain type is a type A, a number of DMRS ports is single, and a number of available symbols in the special slot is less than 4.

6. (canceled)

7. (canceled)

8. The method according to claim 5, wherein determining the at least one first DMRS symbol offset value comprises one of:
determining the at least one first DMRS symbol offset value based on a number of available symbols in the symbol resource and other parameters in the parameters other than the symbol length for data communication in the special slot; or
determining the at least one first DMRS symbol offset value based on the symbol length for data transmission in the special slot and other parameters in the parameters other than the symbol length for data transmission in the special slot.

9. (canceled)

10. The method according to claim 8, wherein determining the first time domain position of the DMRS based on a position of the first available symbol in the symbol resource and the at least one first DMRS symbol offset value comprises:
determining at least one time domain position based on the position of the first available symbol in the symbol resource and the at least one first DMRS symbol offset value;
determining that a time domain position beyond the symbol resource exists in the at least one time domain position, discarding the time domain position beyond the symbol resource in the at least one time domain position to obtain a remaining time domain position, and determining the remaining time domain position as the first time domain position of the DMRS; and
determining that no time domain position beyond the symbol resource exists in the at least one time domain position, and determining the at least one time domain position as the first time domain position of the DMRS.

11. The method according to claim 1, further comprising:
performing DMRS communication based on the first time domain position.

12. The method according to claim 4, before determining the at least one first DMRS symbol offset value based on the parameter configured and/or indicated by the base station, further comprising:
determining at least one second DMRS symbol offset value in the special slot based on the parameter, determining a sum of a symbol numeral of the first symbol in the symbol resource and each second DMRS symbol offset value to obtain at least one second sum value, and determining a symbol corresponding to a symbol numeral and each second sum value as a second time domain position of the DMRS;
determining that the second time domain position satisfies a preset condition, and determining the at least one first DMRS symbol offset value based on the parameter, wherein the preset condition comprises at least one of: the second time domain position conflicting with an unavailable symbol in the special slot, and the second time domain position being not located on the available symbol; and
determining that the second time domain position does not satisfy the preset condition, and performing the DMRS communication based on a time domain position located on the available symbol of the special slot in the second time domain position.

13. A method for configuring a time domain position of a reference signal, performed by a base station, comprising:
determining an available symbol in a special slot and a parameter;
determining a symbol resource for data communication in the special slot and at least one first demodulation reference signal (DMRS) symbol offset value based on the parameter; and
determining a first time domain position of a DMRS based on a first available symbol in the symbol resource and the at least one first DMRS symbol offset value.

14. The method according to claim 13, wherein determining the first time domain position of the DMRS based on the first available symbol in the symbol resource and the at least one first DMRS symbol offset value comprises:
determining a sum of a symbol numeral of the first available symbol in the symbol resource and each of the at least one first DMRS symbol offset value to obtain at least one first sum value; and
determining a symbol corresponding to a symbol numeral and each of the at least one first sum value as the first time domain position of the DMRS.

15. The method according to claim 13, wherein determining the available symbol in the special slot comprises:
determining an unavailable symbol from the special slot;
determining the available symbol to be a symbol in the special slot other than the unavailable symbol;
wherein the unavailable symbol comprises at least one of:
a guard interval symbol used by downlink to uplink conversion;
a downlink symbol for downlink communication;
a symbol for synchronization signal block (SSB) communication;
a symbol allocated to a common search space (CSS);
a symbol occupied by a communication cancel indication (CI); or
a symbol used for business communication with a higher priority than current data communication.

16. The method according to claim 1, wherein the parameter comprises at least one of:
a physical uplink shared channel (PUSCH) mapping type, wherein the PUSCH mapping type comprises a type A and a type B;
a symbol length for data communication in the special slot;
a start symbol position for data communication in the special slot;
a DMRS-additional position;
a number of DMRS ports;
whether to enable intra-slot frequency hopping; or
a front-loaded DMRS-type A position.

17. The method according to claim 16, wherein determining the at least one first DMRS symbol offset value based on the parameter comprises one of:
determining the at least one first DMRS symbol offset value according to a mapping rule of a type B, wherein a PUSCH time domain type comprised in the parameter is the type B;
determining the at least one first DMRS symbol offset value according to a mapping rule of a type A or a type B, wherein a PUSCH time domain type comprised in the parameter is the type A; or
determining the at least one first DMRS symbol offset value according to a mapping rule of a type B, wherein a PUSCH time domain type is a type A, a number of DMRS ports is single, and a number of available symbols in the special slot is less than 4.

18. (canceled)

19. (canceled)

20. The method according to claim 17, wherein determining the at least one first DMRS symbol offset value comprises one of:
determining the at least one first DMRS symbol offset value based on a number of available symbols in the symbol resource and other parameters in the parameters other than the symbol length for data communication in the special slot; or
determining the at least one first DMRS symbol offset value based on the symbol length for data communication in the special slot and other parameters in the parameters other than the symbol length for data communication in the special slot.

21. (canceled)

22. The method according to claim 20, wherein determining the first time domain position of the DMRS based on a position of the first available symbol in the symbol resource and the at least one first DMRS symbol offset value comprises:
determining at least one time domain position based on the position of the first available symbol in the symbol resource and the at least one first DMRS symbol offset value;
determining that a time domain position beyond the symbol resource exists in the at least one time domain position, discarding the time domain position beyond the symbol resource in the at least one time domain position to obtain a remaining time domain position, and determining the remaining time domain position as the first time domain position of the DMRS; and
determining that no time domain position beyond the symbol resource exists in the at least one time domain position, and determining the at least one time domain position as the first time domain position of the DMRS.

23. The method according to claim 13, further comprising:
receiving and demodulating the DMRS based on the first time domain position.

24. (canceled)

25. The method according to claim 13, further comprising:
configuring and/or indicating the parameter to a UE.

26. The method according to claim 13, further comprising sending at least one of a slot format indicator (SFI) dynamic indication signaling or a semi-persistent slot format configuration signaling to a UE.

27. (canceled)

28. (canceled)

29. A communication device, comprising:
a processor; and
a memory having a computer program stored thereon, wherein the processor is configured to:
determine an available symbol in a special slot, and acquire a parameter configured and/or indicated by a base station;
determine a symbol resource for data transmission in the special slot and at least one first demodulation reference signal (DMRS) symbol offset value based on the parameter; and
determine a first time domain position of a DMRS based on a first available symbol in the symbol resource and the at least one first DMRS symbol offset value.

30.-34. (canceled)
